(19) United States
(12) Patent Application Publication
(10) Pub. No.: US 2025/0022081 A1
(43) Pub. Date: Jan. 16, 2025

(54) SYSTEMS, METHODS AND COMPUTER PROGRAM PRODUCTS FOR FACILITATING CO-TENANCY OPPORTUNITIES IN COMMERCIAL REAL ESTATE

(71) Applicant: CoLo Technologies, LLC, Charlotte, NC (US)

(72) Inventors: Richard M. Davies, Charlotte, NC (US); Christopher B. Davies, Charlotte, NC (US); James R. Grams, Charlotte, NC (US)

(21) Appl. No.: 18/767,379

(22) Filed: Jul. 9, 2024

Related U.S. Application Data
(60) Provisional application No. 63/512,782, filed on Jul. 10, 2023.

(51) Int. Cl. G06Q 50/16; G06F 16/29; G06Q 30/0203; G06Q 30/0645

(52) U.S. Cl. CPC G06Q 50/167; G06F 16/29; G06Q 30/0203; G06Q 30/0645

(57) ABSTRACT

A computer implemented method for facilitating co-tenant real estate development includes obtaining, via respective user devices, information from each of a plurality of prospective tenants regarding one or more real estate preferences of each of the plurality of prospective tenants; obtaining, via the respective user devices, geographic location information from each of the plurality of prospective tenants that indicates where each of the plurality of prospective tenants would like to conduct business; and automatically identifying two or more of the plurality of prospective tenants that provided respective geographic location information that is within a predetermined distance threshold of each other and that have compatible preferences.

### RELATED APPLICATION

This application claims the benefit of and priority to U.S. Provisional Patent Application No. 63/512,782 filed Jul. 10, 2023, the disclosure of which is incorporated herein by reference as if set forth in its entirety.

### FIELD OF THE INVENTION

The present invention relates generally to real estate and, more particularly, to commercial real estate.

### BACKGROUND OF THE INVENTION

A business entity desiring to expand locations may find it advantageous to become a co-tenant with another business entity because of more efficient land use and reduced development costs. Unfortunately, it may be difficult for business entities to know when potential co-tenant opportunities are available, particularly since such information is conventionally confidential and not readily available.

The current process for co-tenant property development is to separately contact potential tenants that may be interested in expanding locations, for example via email or telephone, and then to forward site information on the proposed location for continued discussion. The prospective tenant recipient then compares the location to their new (target) location analytics to see if the location might be of interest. This process is highly inefficient, is time consuming, and is typically limited to (a few) trusted relationships willing to share confidential target trade area information.

Given limited time to procure co-tenants for a multi-tenant location (typically 90-120 days of due diligence in a land purchase or sale agreement) multi-tenant development may not be feasible. In summary, the traditional method of procuring land and then trying to opportunistically procure co-tenants via limited relationships is inefficient and typically unproductive, given the time limitations.

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

The present invention introduces an innovative real estate system designed to aggregate tenant demand for real estate site locations, optimize co-tenancy opportunities, and ensure the confidentiality of tenant information.

The system enables tenants or tenant representatives to input their targeted real estate trade areas (i.e., desired geographic locations for a business) and tenant site requirements (if more confidentiality is desired, representatives can enter by category, e.g. pizza restaurant rather than a tenant name). The system then facilitates tenant site demand aggregation within each trade area. This results in much improved opportunities for co-tenancy, combining tenant searches in the same trade area while protecting sensitive tenant information. The system connects tenants searching the same trade area at roughly the same time, allowing for more efficient co-tenancy land use and the potential for reduced costs and/or better locations. Co-tenancy cost optimization is achieved by more efficient land use and reduced development pricing as a result of economics of scale, and is driven by analyzing aggregated demand data, and by identifying potential co-tenancy opportunities in target trade areas to create synergistic co-tenancy opportunities among expanding companies. Co-tenancy data drives location procurement rather than speculative land interests being shopped to prospective co-tenants.

The system places paramount importance on maintaining the confidentiality of tenant information. The system employs state-of-the-art security measures and follows industry-leading data privacy protocols. For example, two-factor authentication may be utilized for users logging into the system, and device-detection may be utilized to require users to enter a code from their email when using an untrusted or unrecognized device. The system may utilize, for example, PBKDF2 (Password-Based Key Derivation Function 2), HMAC (Hash-based Message Authentication Code), and SHA512 (Secure Hash Algorithm) to hash passwords with salt values, and the software application is only accessible through HTTPS (Hypertext Transfer Protocol Secure). All data received and stored in the database(s) is encrypted.

Tenant information, including general site requirements and business preferences, is securely stored and handled in compliance with applicable laws and regulations, such as data protection regulations and non-disclosure agreements. The system ensures that tenant data remains strictly confidential and is only shared with authorized parties involved in the site selection process, such as tenant approved tenant representatives, tenant approved property owners, tenant approved developers, and tenant approved co-tenants.

When tenants sign up for the system, they are prompted to provide their general site requirements, allowing them to outline their specific needs. These requirements may include criteria such as, but not limited to, the necessity for a “drive-thru” facility, desired acreage, the number of parking spaces, building square footage, desired traffic counts, their competitors, their competitor categories, land cost range, rent range, and/or approved co-tenants. System users are also prompted to enter whether they are an approved representative for a tenant in the trade area and whether or not this approval is exclusive. By inputting these preferences, tenants can effectively communicate their site requirements, ensuring that the system generates tailored co-tenancy and site recommendations based on their specific needs. Tenants will be vetted prior to gaining access to the system.

The system's advanced algorithms analyze the aggregated demand data and compare it with available real estate options. For example, once co-tenant demand is aggregated for a trade area, the size(s) of property needed is calculated, either manually or via an algorithm with tenant inputting, for example, building square footage and parking spaces needed, and land size can be determined in aggregate. Land lots are researched, either manually or via an algorithm, using county databases or other sources, such as LANDGLIDE®, GEOTHINQ®, etc., to provide land lot options including land lot assemblies. Such databases and sources are accessible to developers and brokers from any computer, tablet or phone.

By cross-referencing (1) tenant site preferences and/or (2) property zoning, and/or (3) possible available sites and/or (4) property sizes available in target trade areas, the system identifies potential co-tenancy opportunities that align with the specific site requirements of tenants. This optimization process helps tenants unlock cost savings through shared resources, collaboration, and synergistic partnerships, while also promoting economic growth in the desired real estate markets.

Throughout the entire process, the system maintains the utmost confidentiality of tenant information. Confidential data is securely encrypted using industry-standard encryption protocols, and access is strictly limited to authorized users involved in the site selection process including a developer who has agreed to do horizontal development on the land under strict confidentiality. Rigorous access controls and audit trails are implemented to ensure that only relevant and authorized personnel have access to tenant data. These measures create a trusted environment that encourages tenants to freely input their requirements, confident that their sensitive business information will be protected.

In summary, the real estate system of the present invention provides a comprehensive solution for aggregating tenant demand, optimizing co-tenancy opportunities, and safeguarding the confidentiality of tenant information. By enabling tenants to input their specific site requirements while adhering to rigorous data privacy and security protocols, the present invention empowers tenants to make informed decisions, capitalize on co-tenancy opportunities, and protect their sensitive business information. The present invention represents a significant advancement in the real estate industry, fostering collaboration, efficiency, and trust in the tenant location selection and procurement process, resulting in improved opportunities to access better sites at lower costs.

Embodiments of the present invention provide a computer implemented method and system for facilitating co-tenant real estate development. The method includes obtaining, via respective user devices, information from each of a plurality of prospective tenants (or their representatives) regarding one or more real estate preferences of each of the plurality of prospective tenants; obtaining, via the respective user devices, geographic location information from each of the plurality of prospective tenants that indicates where each of the plurality of prospective tenants would like to conduct business; and automatically identifying two or more of the plurality of prospective tenants that provided respective geographic location information that is within a predetermined distance threshold of each other. The term “predetermined distance threshold” is intended to include geographic areas or locations that overlap with each other or that are in close proximity, for example within a predefined distance of each other. For example, in some embodiments, a predefined distance may be two miles. However, embodiments of the present invention are not limited to any particular predefined distance. Various predefined distances may be utilized without limitation, including distances less than two miles and distances greater than two miles, for example. With respective to overlapping geographic areas, the term “predetermined distance threshold” is intended to include any degree of overlapping.

In some embodiments, the information regarding real estate preferences is obtained from the plurality of prospective tenants through at least one user interface displayable on a display of each of the respective user devices. Such information may include one or more of the following: building square footage information, land parcel size information, parking space information, building type, type of drive-thru, site visibility and access information, vehicle traffic count information, household income information in a surrounding area, approved competitors, and unapproved competitors. Such information may also include tenant customer demographic information and/or tenant customer profile information. This information may be obtained from a representative of a prospective tenant, also, such as an analytics company vendor, etc.

In some embodiments, the location information is obtained from each of the plurality of prospective tenants or their representatives through a user interactive map of a geographic region that is displayable on a display of the respective user devices. The location information can be provided by positioning a location indicator (such as a “pin”) on the user interactive map and/or by entering longitude and latitude coordinates (or other directional information) within a user interface associated with the user interactive map, and/or from hotspots, trade area locations, or other designated location information uploaded in common file formats. The location information can be obtained by allowing a tenant to draw an area of interest on a map, also.

The computer system is also configured to prohibit competitor location “matches” in order to avoid competitor target trade area disclosure. Thus, the system is configured such that, if at least one of two prospective tenants that have indicated that they are competitors select the same geographic trade area, no co-tenancy agreements can be entered between the two prospective tenants. Moreover, each prospective tenant is prevented from learning about the target trade area of the other.

In some embodiments, in response to automatically identifying the two or more of the plurality of prospective tenants that provided the respective geographic location information that is within a predetermined distance threshold of each other, the method further includes automatically determining if the two or more prospective tenants have one or more similar real estate preferences and, in response to automatically determining that the two or more prospective tenants have one or more similar real estate preferences, then transmitting generic information about each of the identified two or more prospective tenants over a communications network to respective user devices of the two or more prospective tenants. This match can be reviewed by an administrator prior to being released to the prospective tenants to ensure there is a developer willing to take on the horizontal work.

In some embodiments, the method further includes automatically determining whether it is acceptable under one or more existing agreements entered into by the two or more prospective tenants to disclose an identity of each of the two or more prospective tenants to each other and, in response to determining that it is acceptable to disclose the identity of each of the two or more prospective tenants to each other, transmitting the identity of each of the two or more prospective tenants to each other over the communications network to the respective user devices, and displaying the geographic location information of the two or more prospective tenants via the respective user devices. The method further includes, in response to disclosing the identity of each of the two or more prospective tenants to each other, obtaining, via the respective user devices, an indication from each of the two or more prospective tenants if the two or more prospective tenants agree to enter into at least one of a co-tenancy development agreement, a co-tenancy leasing agreement, or a co-land use agreement with each other. Contact information is entered upon agreeing upon a match with only category and location revealed.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 illustrates a user interface configured to receive information about real estate needs and preferences from prospective tenants in accordance with some embodiments of the present invention.

FIG. 2 is a user interface that prospective tenants use to identify desired site locations in accordance with some embodiments of the present invention.

FIG. 3 is a flowchart of operations for identifying co-tenant opportunities, according to some embodiments of the present invention.

FIG. 4 is a block diagram that illustrates details of an example processor and memory that may be used in accordance with embodiments of the present invention.

FIGS. 5-30 are example user interfaces for implementing embodiments of the present invention.

FIG. 31 is a flowchart of operations for identifying co-tenant opportunities, according to some embodiments of the present invention.

FIGS. 32-33 are example user interfaces for implementing embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof, are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,” which derives from the Latin phrase “exempli gratia,” may be used to introduce or specify a general example or examples of a previously mentioned item, and is not intended to be limiting of such item. The common abbreviation “i.e.,” which derives from the Latin phrase “id est,” may be used to specify a particular item from a more general recitation.

It will be understood that although the terms first, second, third, etc., may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present inventive concepts. The same reference numerals or the same reference designators denote the same or similar elements throughout the specification.

The term “target trade area”, as used herein, means a geographic area or location where a business entity (e.g., a sole proprietorship, a partnership, a limited liability company, a corporation, etc.) would like to establish a presence and conduct business. A target trade area may include, but is not limited to, a specific address, a specific street or portion of a street, a specific zip code, a specific area within a town or city, or any area defined by a polygon or circle on a map, etc. Typically, a business entity selects a target trade area based on 1) the area's infrastructure and other attributes, such as local geography, transportation infrastructure, traffic patterns, and road layout, 2) the competitive landscape, such as an area's capacity to attract customers, the competition in the area, etc., and 3) demographics and area characteristics, such as the characteristics, habits, and preferences of the local community and visitors to the area.

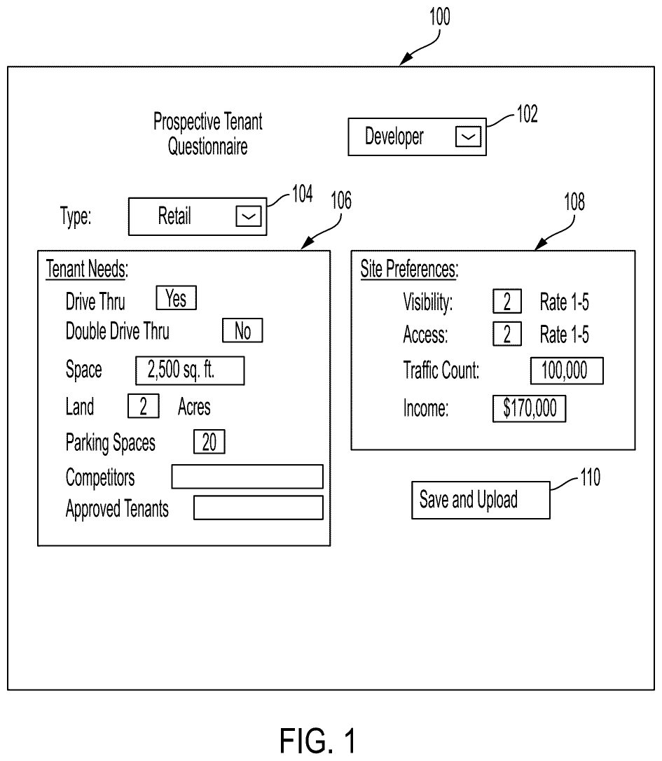

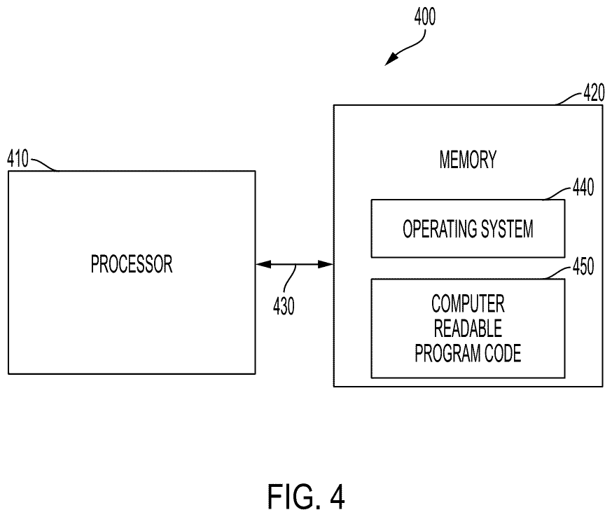

FIG. 1 illustrates a user interface 100 generated and made available to a user device (e.g., a computer, tablet, smart phone, etc.) by a computer system 400 (FIG. 4) and that is configured to receive information regarding real estate site preferences from prospective tenants (i.e., any organization created to conduct business, such as sole proprietorship, a partnership, a limited liability company, a corporation, etc.) in accordance with some embodiments of the present invention. This information may be obtained from a representative of a prospective tenant, also, such as an analytics company vendor, a broker, etc. The illustrated user interface 100 includes a graphical user interface (GUI) control (e.g., a drop down box) 102 that allows the prospective tenant to identify a developer 102 (i.e., an entity that will direct the development of a commercial property at the location). The illustrated user interface 100 also includes a drop down box GUI control 104 that allows the prospective tenant to identify the type of site that is needed, e.g., a retail site, an industrial site, a medical site, etc. The illustrated user interface 100 includes a “Tenant Needs” information box 106 that allows the prospective tenant to specify various site requirements and preferences. For example, in the illustrated embodiment, the prospective tenant has identified that the site desired is a retail site. The information box 106 allows the prospective tenant to then specify whether a drive-thru lane or a double drive-thru lane is needed, the square footage of the building space needed, the land parcel size needed, and the number of parking spaces needed via various GUI controls. In the illustrated embodiment, the prospective tenant has specified that a drive-thru is required, that the building interior space needed is 2,500 square feet, that the land parcel size needed is 2 acres, and that 20 parking spaces are needed.

The illustrated user interface 100 also includes a “Site Preferences” information box that allows the prospective tenant to specify desired characteristics of the site. For example, in the illustrated embodiment, the information box 108 allows the prospective tenant to specify, on a scale from 1 to 5, the visibility and access characteristics desired of the site via respective GUI controls. As would be understood by one of skill in the art of the present invention, visibility refers to how easily a site can be seen from a nearby road, and access refers to how easily the site can be accessed from the nearby road (i.e., how easy is it to enter and leave the site from a nearby road or roads). The illustrated information box 108 also allows the prospective tenant to specify a desired traffic count (vehicles per day) for a road near the site and a desired average level of household income in the area of the site via respective GUI controls. In the illustrated embodiment, the prospective tenant has specified a visibility and access rating of 2, a traffic count of 100,000 vehicles per day, and an average household income level of $170,000.

A prospective tenant can save and upload the information entered via user interface 100 into data storage (e.g., one or more databases, etc.) of or accessible by the computer system 400 via GUI control 110. This information can be subsequently accessed and edited by the prospective tenant, as well.

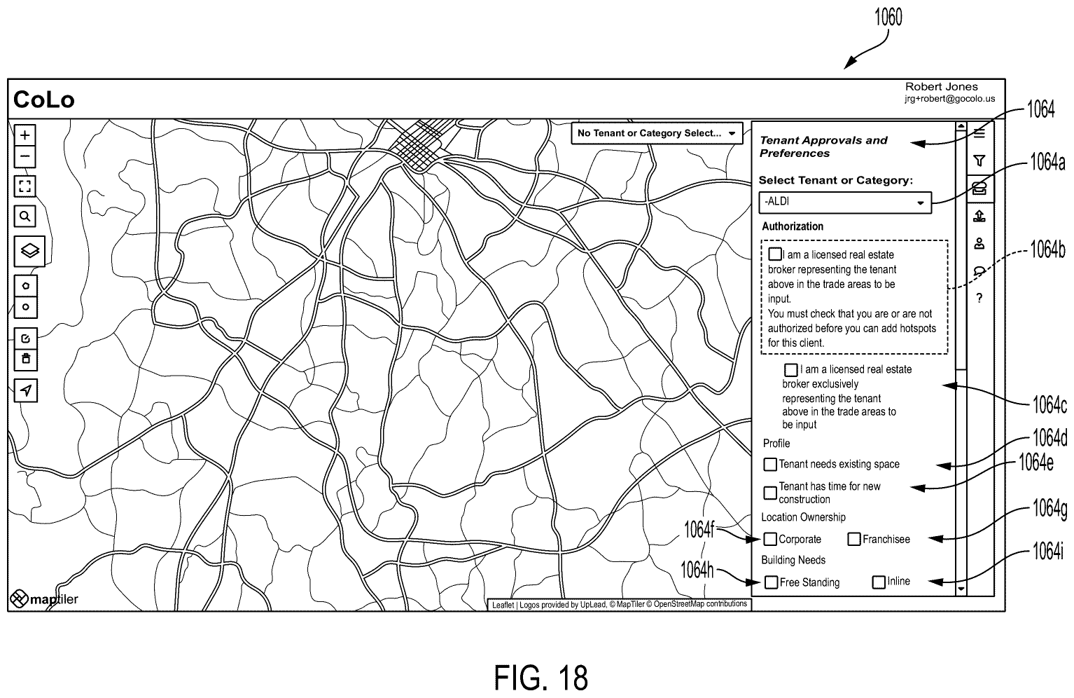

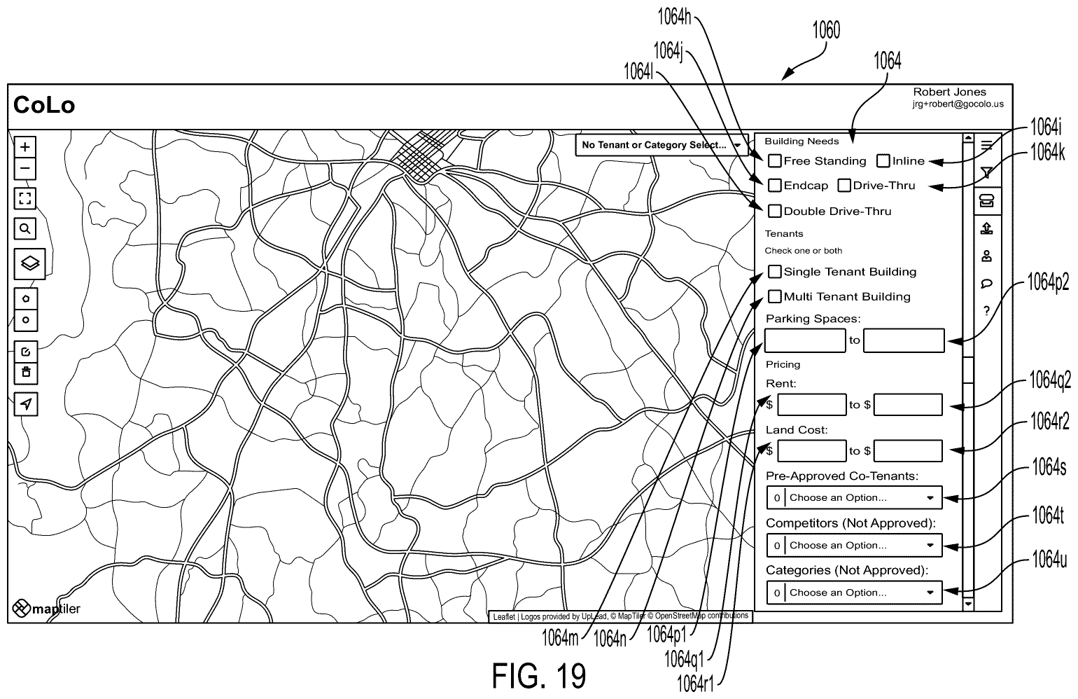

Embodiments of the present invention are not limited to the illustrated user interface 100 in FIG. 1. User interfaces for receiving site preference information from prospective tenants can have various configurations and GUI controls. For example, FIGS. 18-19 illustrate other user interfaces for receiving site preference information in accordance with embodiments of the present invention.

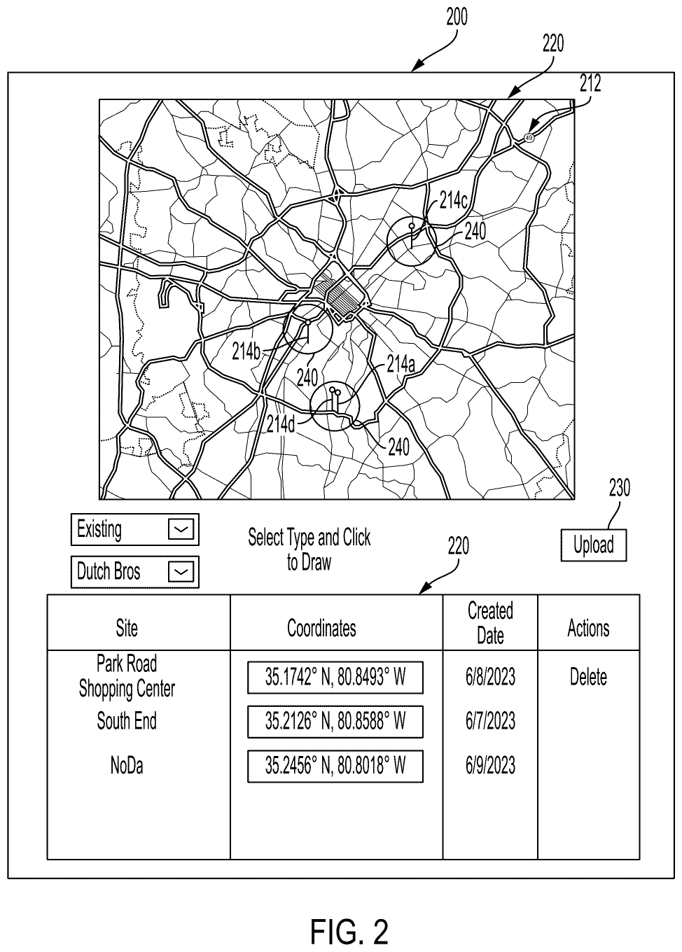

FIG. 2 is a user interface 200 generated and made available to a user device by the computer system 400 (FIG. 4) and that prospective tenants can use to identify desired site locations (i.e., target trade areas) in accordance with some embodiments of the present invention. The illustrated user interface 200 includes an upper portion 210 and a lower portion 220. The upper portion 210 is configured to display a user interactive geographical map 212. A prospective tenant can place a location indicator (e.g., a “pin”) 214 directly on the map 212 to identify a location or area of interest (i.e., a target trade area). Location indicators can also be added through an import function, for example as in Google Maps and Apple Maps. The import function allows users to upload a file (e.g., a csv file, etc.) with latitude and longitude information, and an optional radius, to quickly populate the map with points/areas indicating target trade areas. The import function also accepts .kml or .kmz files to quickly populate the map with polygons, circles, or points (points will have a default radius applied).

In response to placing a pin at a location on the map 212 or otherwise indicating one or more locations or areas of interest, information about the selected location/area is displayed in the lower portion 220 of the user interface 200. For example, the name of the area of a location, the coordinates of the location, and the date the pin was placed on the map at the location are displayed. In FIG. 2, a prospective tenant has placed three pins 214a, 214b, 214c on the map 212 corresponding to the locations identified in the lower portion 220 of the user interface 200.

Alternatively, a prospective tenant may enter the information directly in the lower portion 220 of the user interface 200 and a pin 214 will appear at the location on the map 212 in the upper portion 210 of the user interface 200. Once one or more locations are identified by a prospective tenant (or tenant representative), the information is saved and uploaded into data storage of the computer system 400 via GUI control 230. This information can be subsequently accessed and edited by the prospective tenant (or tenant representative), as well.

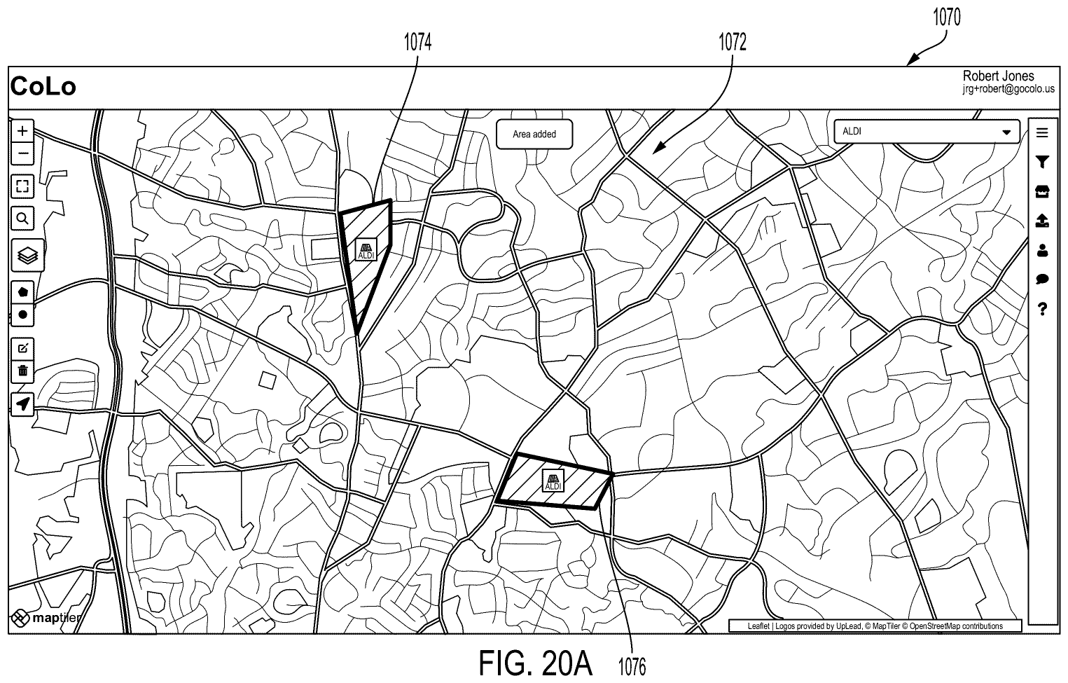

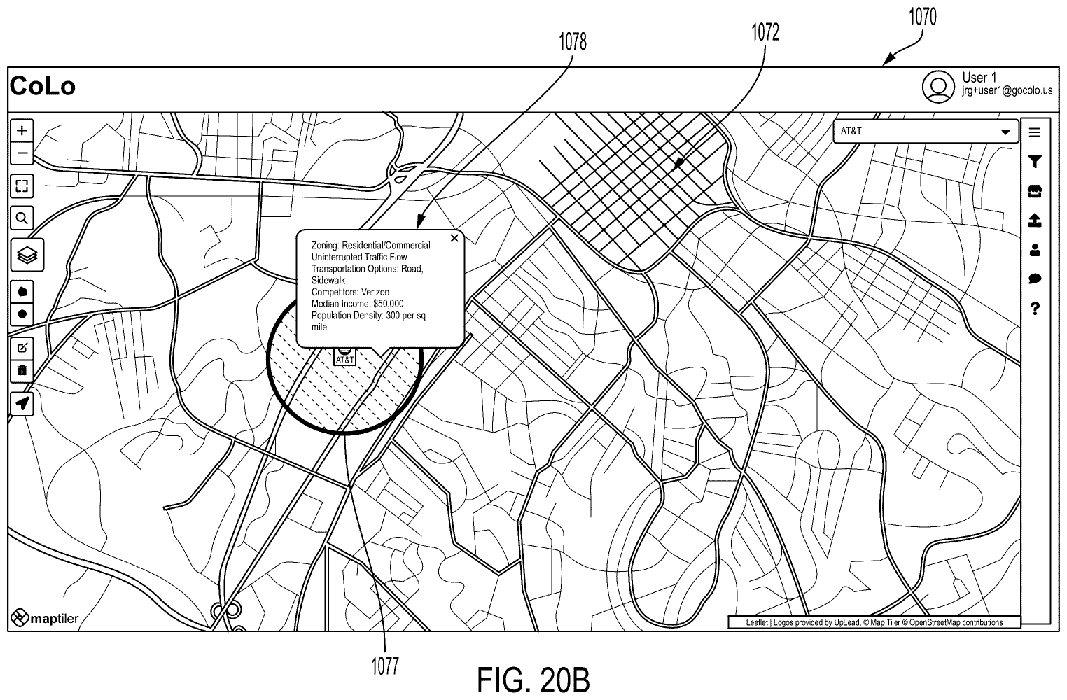

Once a prospective tenant has entered their information, the computer system 400 generates a “ring” or custom drawn shape 240 at each location. For example, a ring having a 1.5 mile radius (3 mile diameter) may be generated and displayed upon the map 212. Alternatively, a custom drawn shape (e.g., a polygon 1076, as illustrated in FIG. 20) having a perimeter around a trade area may be generated and displayed upon the map 212. These rings/shapes 240 are not visible to other prospective tenants, however. The purpose of the ring or custom drawn shape 240 is to identify visually when two or more prospective tenants have indicated an interest in locations that are close (i.e., within a predetermined distance) to each other. For example, in some embodiments, a predetermined distance may be two miles. However, embodiments of the present invention are not limited to any particular distance. Various distances may be utilized without limitation, including distances less than two miles and distances greater than two miles.

Proximity for matching purposes may be established using other methods besides a map. For example, coordinate points forming a polygon or circle uploaded in a .csv file, locations in .kmz files, or locations in .kml files, etc., may be utilized to identify matches.

In the illustrated embodiment of FIG. 2, another prospective tenant has placed a pin 214d at a location close to the location of pin 214a. The computer system 400 automatically recognizes this and notifies the selected developer of a “match”, i.e., that two tenants are interested in the same location or locations that are close together or within their targeted trade area (i.e., within a predetermined distance of each other). The computer system 400 automatically determines, based on previously provided information from the two prospective tenants, whether there are any restrictions on the two prospective tenants being co-tenants (i.e., self-imposed restrictions or other restrictions). In addition, the computer system 400 is configured to automatically determine if the two prospective tenants have one or more similar real estate preferences and, if so, the computer system 400 shares generic information with each prospective tenant via their respective user devices (i.e., transmits the generic information to the user devices via a communications network). In addition, the computer system 400 may be configured to automatically determine whether it is acceptable under one or more existing agreements entered into by the two prospective tenants for the identity of each prospective tenant to be disclosed to each other and, if acceptable, the computer system 400 is configured to disclose the identity of each prospective tenant to each other via their respective user devices. In response to disclosing the identity of each prospective tenant to each other, the computer system 400 may be configured to obtain, via the respective user devices, an indication from each prospective tenant if they agree to enter into at least one of a co-tenancy development agreement, a co-tenancy leasing agreement, and a co-land use agreement with each other.

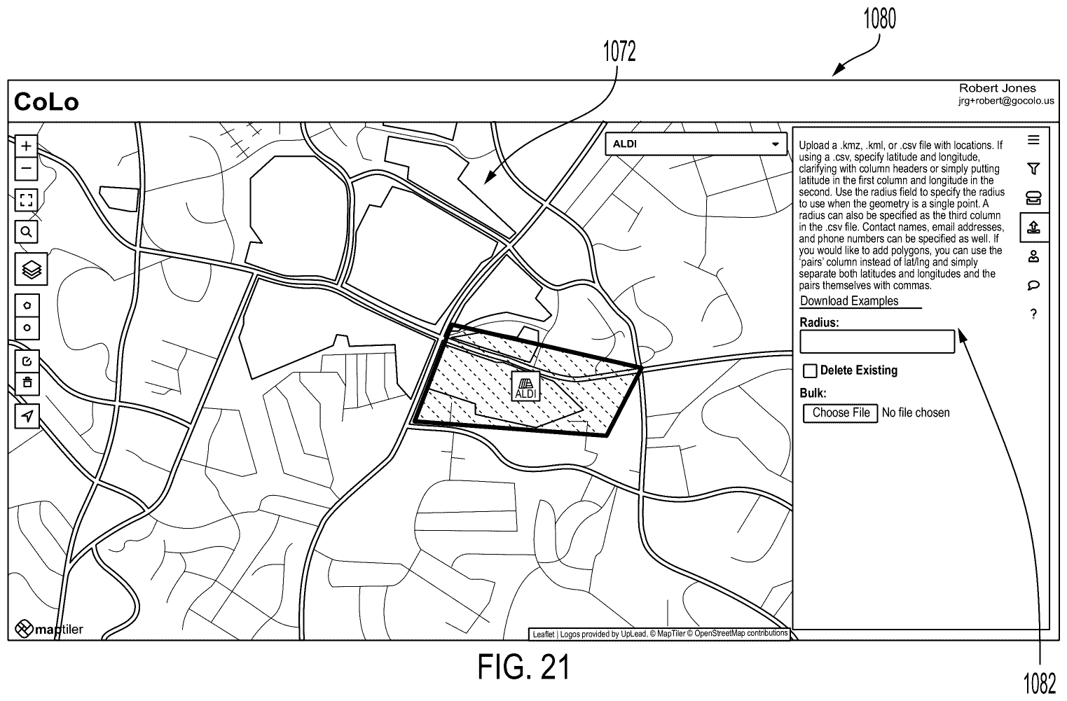

Embodiments of the present invention are not limited to the illustrated user interface 200 in FIG. 2. User interfaces for receiving geographic location information for desired target trade areas from prospective tenants can have various configurations and GUI controls. For example, FIGS. 20-21 illustrate other user interfaces for receiving geographic location information in accordance with embodiments of the present invention.

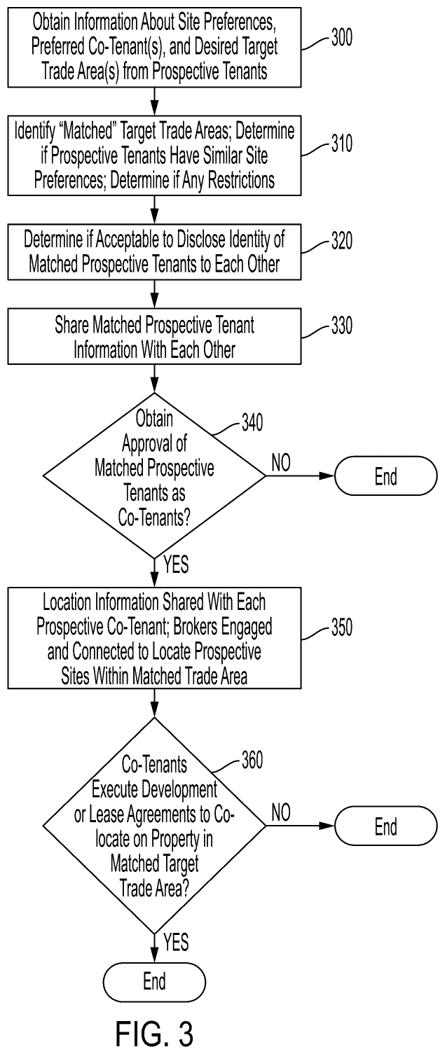

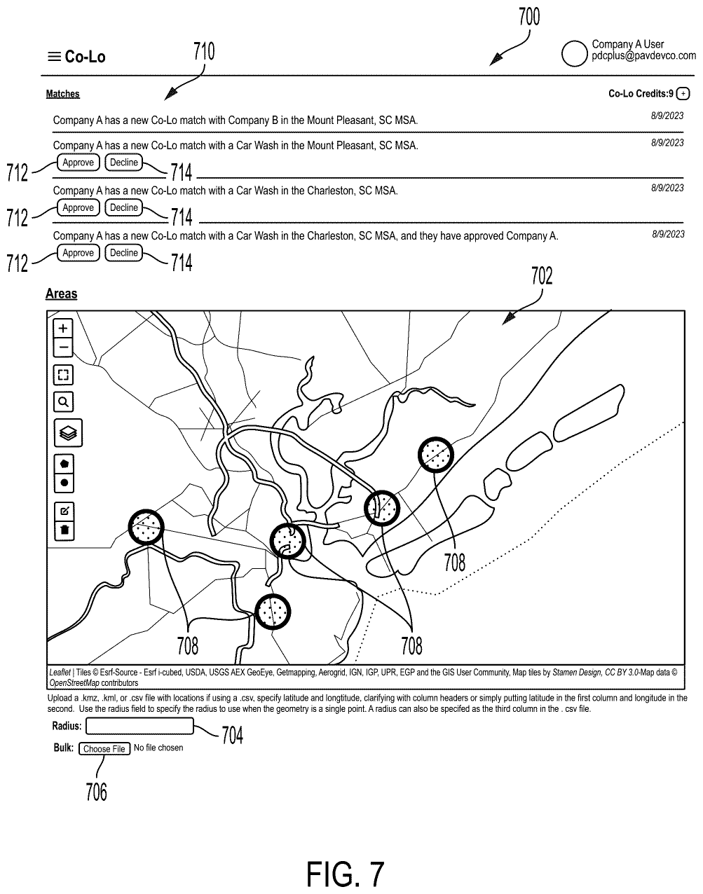

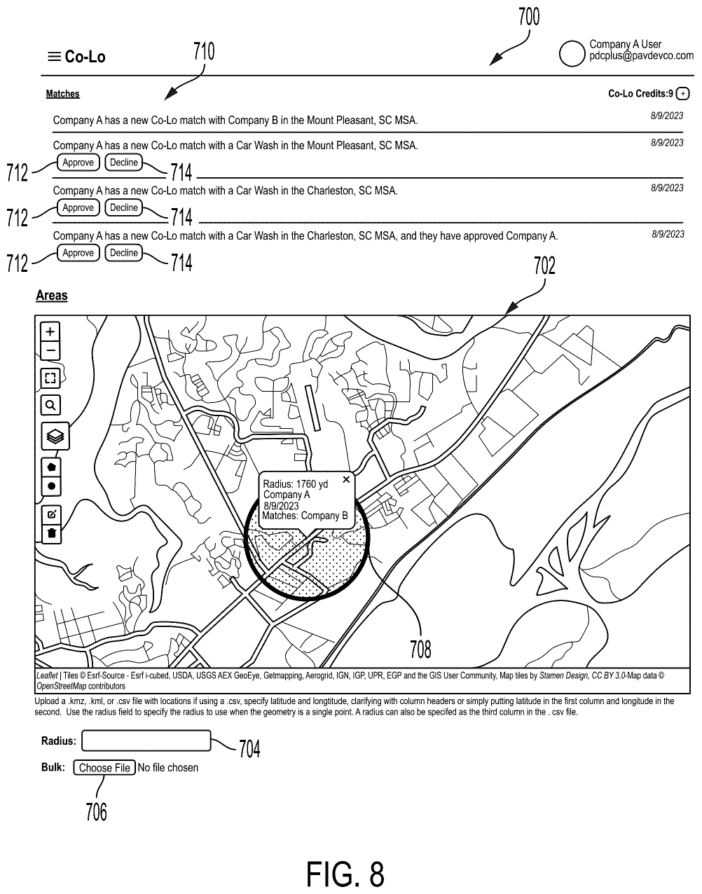

Referring now to FIG. 3, overall operations of some embodiments of the present invention are further described. Initially, each prospective tenant or tenant representative (i.e., each “user”) accesses the computer system 400 (FIG. 4) and provides information about site preferences and preferred co-tenants via a user interface (e.g., 100, FIG. 1; 600, FIG. 6; 1060, FIGS. 18-19) displayed on a user device. The prospective tenant also identifies/selects target trade areas, i.e., locations of interest, via a user interface (e.g., 200, FIG. 2; 700, FIGS. 7-8; 1070, FIG. 20; 1080, FIG. 21) (Block 300). The computer system 400 automatically identifies when two or more prospective tenants have common areas of interest (i.e., “matched” target trade areas) (Block 310). In addition, the computer system 400 determines if the prospective tenants having matched target trade areas have similar site preferences and/or if there are any restrictions with the prospective tenants being co-tenants (Block 310).

The computer system determines if it is acceptable to disclose the identity of each of the prospective tenants having matched target trade areas to each other after a developer has agreed to move forward with the matched tenants to do horizontal site work, for example, based on one or more existing agreements entered into by the prospective tenants (Block 320). If acceptable, the computer system 400 shares the identity and/or other information with each of the prospective tenants via respective user devices (Block 330). This information may be shared under a non-disclosure agreement, for example. Such information may include, but is not limited to, the type of tenancy and the brand names of each “matched” prospective tenant. For example, if one of the prospective tenants is Starbucks and the other prospective tenant is Chipotle, their categories may be shared with each other, but not the specific trade area location where they matched or their names. Once a prospective tenant agrees to see the match, which may require payment of a fee, the trade area and names are revealed. The prospective tenants may match multiple times, in which case they will have to agree multiple times to see the location. If prospective tenants have listed each other as preferred, their match will be prioritized when notified. If one has listed the other as a competitor, no match will be provided, in order to protect prospective tenant competitor confidentiality.

If each of the “matched” prospective tenants approves the other(s) as a co-tenant (Block 340), then the trade area location information is shared with each prospective tenant (Block 350). In addition, each prospective tenant agrees to provide a prospective tenant-selected developer a set time frame to work with one or more real estate brokers to identify an available site in the desired location. Site plans and budgets are then developed, conventionally by the prospective tenant-selected developer. The “matched” prospective tenants then execute development or lease agreements to co-locate on an available site in the matched target trade area (Block 360).

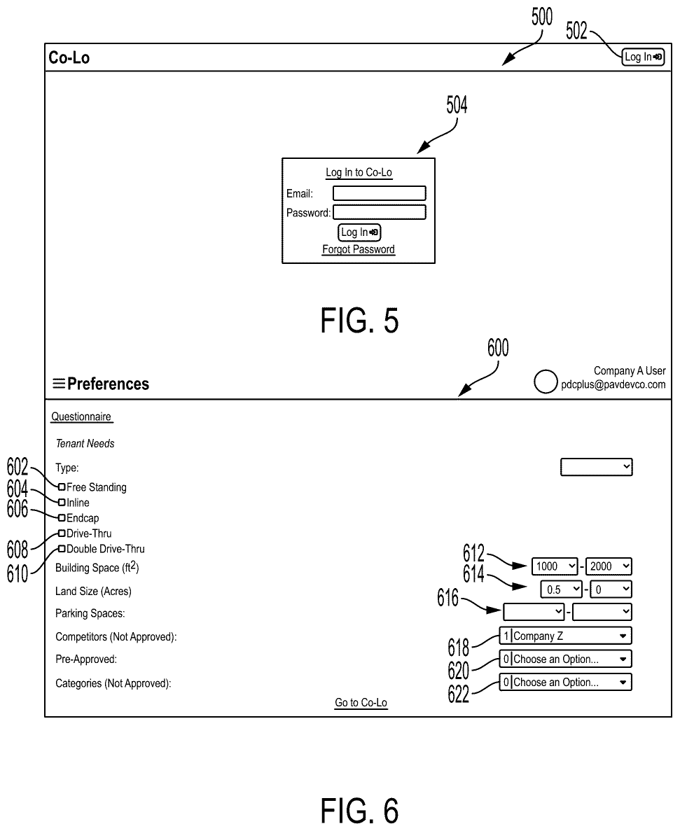

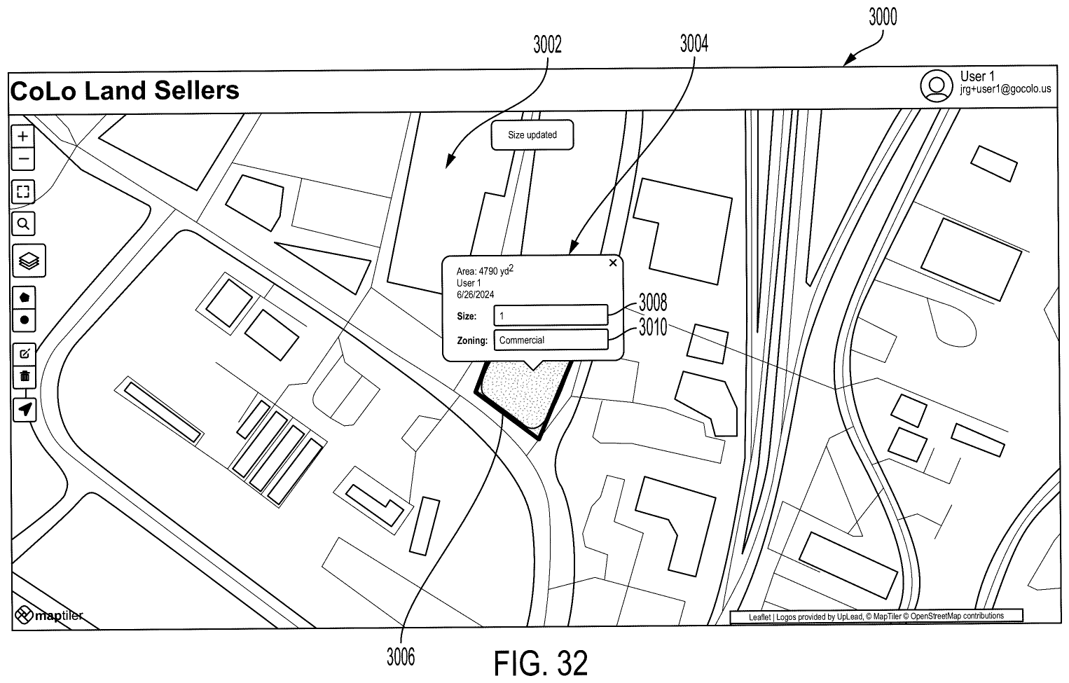

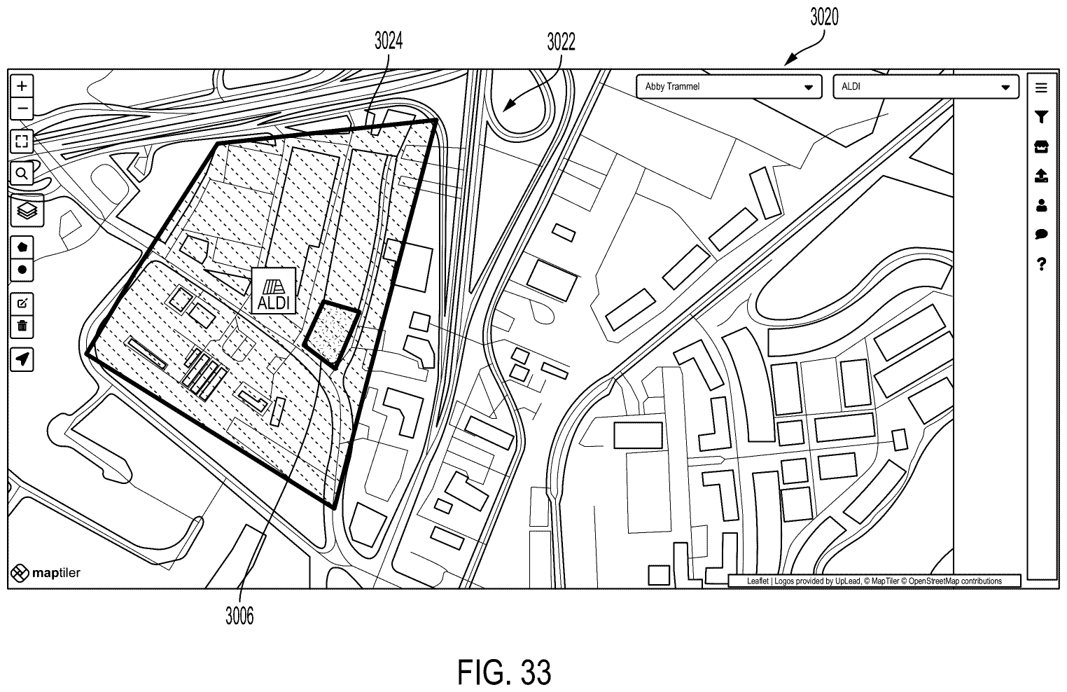

FIG. 4 is a block diagram that illustrates details of an example processor 410 and memory 420 that together act as a computer system 400 for implementing various embodiments of the present invention. The processor 410 communicates with the memory 420 via an address/data bus 430. The processor 410 may be, for example, a commercially available or custom microprocessor. Moreover, the processor 410 may include multiple processors. The memory 420 may be a non-transitory computer readable storage medium and may be representative of the overall hierarchy of memory devices containing the software and data used to implement the user interface 100 (FIG. 1), user interface 200 (FIG. 2), user interfaces 500, 600, 700, 1000, 1010, 1020, 1030, 1040, 1050, 1060, 1070, 1080, 1090, 1100, 1110, 1200 (FIGS. 5-30), and user interfaces 3000, 3020 (FIGS. 32-33) as described herein, as well as perform the various other functions described herein. The memory 420 may include, but is not limited to, the following types of devices: cache, ROM, PROM, EPROM, EEPROM, flash, static RAM (“SRAM”), and dynamic RAM (“DRAM”).

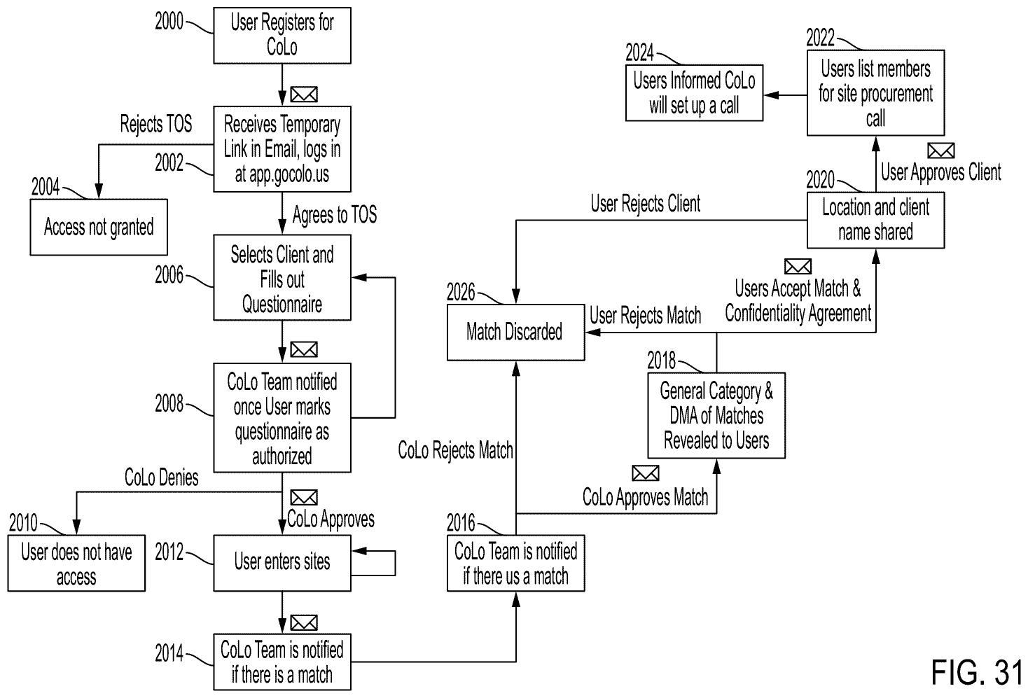

As shown in FIG. 4, the memory 420 may hold various categories of software and data, such as computer readable program code 450 and/or an operating system 440. The operating system 440 controls operations of a server or other device that displays the user interface 100 (FIG. 1), user interface 200 (FIG. 2), user interfaces 500, 600, 700, 1000, 1010, 1020, 1030, 1040, 1050, 1060, 1070, 1080, 1090, 1100, 1110, 1200 (FIGS. 5-30), and user interfaces 3000, 3020 (FIGS. 32-33) to a user, for example via a respective user device. In some embodiments, the operating system 440 may manage the resources of the server and may coordinate execution of various programs by the processor 410. For example, the computer readable program code 450, when executed by a processor 410, may cause the processor 450 to perform any of the operations illustrated in the flowcharts of FIGS. 3 and 31, as well as display the user interfaces 100, 200, 500, 600, 700, 1000, 1010, 1020, 1030, 1040, 1050, 1060, 1070, 1080, 1090, 1100, 1110, 1200, 3000, 3020 and store and analyze data collected therefrom.

In some embodiments, the present invention utilizes servers that run in the cloud, and users access the system 400 with a web browser. All Chromium-based browsers are supported alongside Mozilla Firefox and Safari. Windows, Mac, iOS, Android, and Linux distributions that support these browsers will all be suitable for embodiments of the present invention.

FIGS. 5-10 are example user interfaces for implementing the present invention, according to some embodiments. FIG. 5 illustrates an exemplary log-in user interface 500 that a prospective tenant uses to access the computer system 400 via the internet or other computer network. The log-in user interface 500 is configured to be displayed on a user device and includes a log-in GUI control 502 that is configured to display the log-in window 504 in response to user activation. The prospective tenant enters an email address and password to gain entry to the system, as would be understood by those of skill in the art of the present invention.

Once logged in, a prospective tenant can access a user interface 600 (FIG. 6) that is configured to receive the prospective tenant's site preference information. In the illustrated user interface 600, a prospective tenant can indicate preferences via GUI controls 602-610. For example, the prospective tenant can indicate that a free standing site is desired via GUI control 602, that an inline site is desired via GUI control 604, that an endcap site is desired via GUI control 606, that a drive-thru is desired via GUI control 608, and/or that a double drive-thru is desired via GUI control 610. The prospective tenant can indicate the desired building square footage via GUI control 612 and the desired land/parcel size (e.g., in acres, etc.) via GUI control 614. In addition, the prospective tenant can indicate the number of parking spaces needed in GUI control 616.

In the illustrated user interface 600, the prospective tenant can select from a drop down list GUI control 618 competitors of the prospective tenant that the prospective tenant does not want to become a co-tenant with. In addition, the prospective tenant can select from a drop down list GUI control 620 approved other prospective tenants that the prospective tenant is okay with becoming a co-tenant with. Also, in the illustrated user interface 600, the prospective tenant can select from a drop down list GUI control 622 categories of businesses of other prospective tenants that the prospective tenant does not want to become a co-tenant with.

Once site preference information is entered, the prospective tenant utilizes user interface 700 (FIG. 7) to identify/select target trade areas via a geographic map 702 displayed in the user interface 700. If the prospective tenant specifies a point on the geographic map 702, GUI control 704 allows the prospective tenant to specify a radius from the location that produces a ring around an acceptable target trade area for the prospective tenant. Alternatively, the user interface 700 allows the prospective tenant to identify/select target trade areas by uploading one or more files (e.g., a .kmz file, a .kml file, or a .csv file) via GUI control 706. The uploaded file(s) contains geographic information and, when displayed as the geographic map 702, is configured to indicate target trade areas of the prospective tenant. In the illustrated embodiment of FIG. 7, the displayed geographic map 702 displays five target trade areas 708 selected by a prospective tenant.

Matches between the prospective tenant (Company A) and other prospective tenants identified by the computer system 400 are displayed in area 710 of the user interface 700. In the illustrated embodiment, the prospective tenant (Company A) has a match with a Car Wash (Company B) in Mount Pleasant, South Carolina and in Charleston, South Carolina. In addition, the prospective tenant (Company A) has a match with a Car Wash (Company B) in Charleston, South Carolina and Company B has already approved Company A as a co-tenant. The illustrated user interface 700 allows Company A to approve or decline a co-tenancy arrangement with Company B via GUI controls 712, 714, respectively.

In FIG. 8, the computer system 400 has identified a match between two prospective tenants (Company A and Company B) and this information is displayed within the ring 708 in geographic map 702. The computer system 400 is configured to hide the display of desired trade areas (i.e., geographic location information) and other information about a potential co-tenant to another potential co-tenant until confidentiality agreements have been entered into. For example, a desired trade area of Company A will only be displayed to a user device associated with Company A and a desired trade area of Company B will only be displayed to a user device associated with Company B. Once a confidentiality agreement is in place, the desired trade areas of Company A and B can be shared with each other.

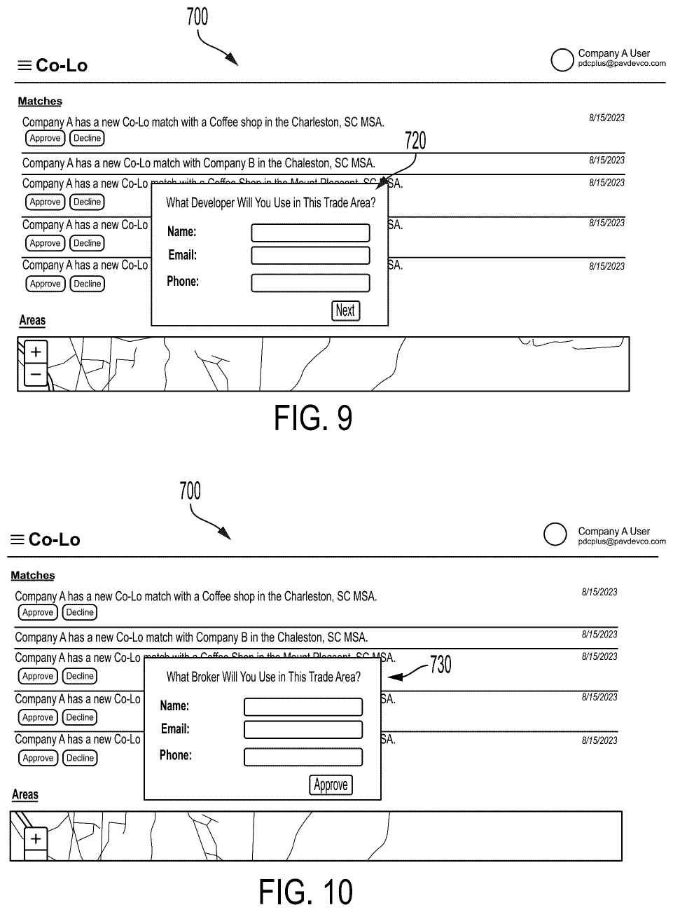

Once Company A has approved a co-tenancy arrangement with Company B via GUI control 712, the user interface 700 displays a window 720 (FIG. 9) that allows Company A to identify and provide information about a developer that Company A will use to develop the property at the target trade area. The user interface 700 also displays a window 730 (FIG. 10) that allows Company A to identify and provide information about a broker that Company A would like to utilize to locate a property within the identified target trade area. Contact information for various stakeholders, not limited to brokers, can be associated with matches through the user interface. Contact information provided here will be shared among matched parties within the application to set up an initial site procurement call.

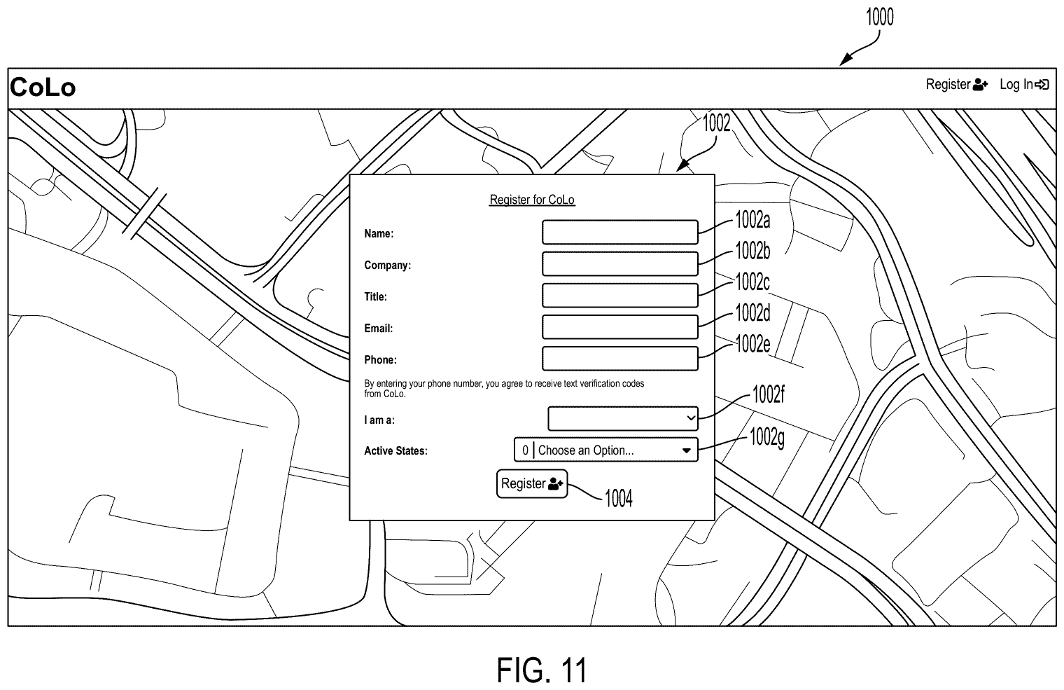

FIGS. 11-33 are example user interfaces for implementing the present invention, according to some embodiments. FIG. 11 illustrates a registration user interface 1000 that a prospective user (e.g., a broker or tenant) may use to register via the internet for access to the computer system 400. The registration user interface 1000 is configured to be displayed on a user device (e.g., a computer, tablet, smart phone, etc.) and includes a registration panel 1002 in which the prospective user can enter various information. Such information may include, but is not limited to, user name (via input box 1002a), user company (via input box 1002b), user title (via input box 1002c), user email (via input box 1002d), user phone number (via input box 1002e), whether the user is a broker or potential tenant (via input box 1002f), and active states in which brokers or users are currently doing business, e.g., North Carolina, South Carolina, etc. (via input box 1002g). Once the information is entered, the prospective user submits the information to the computer system 400 via GUI control 1004.

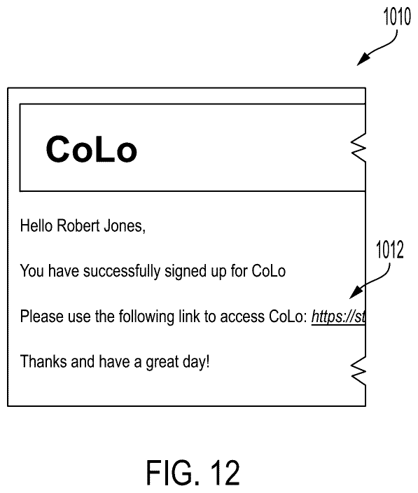

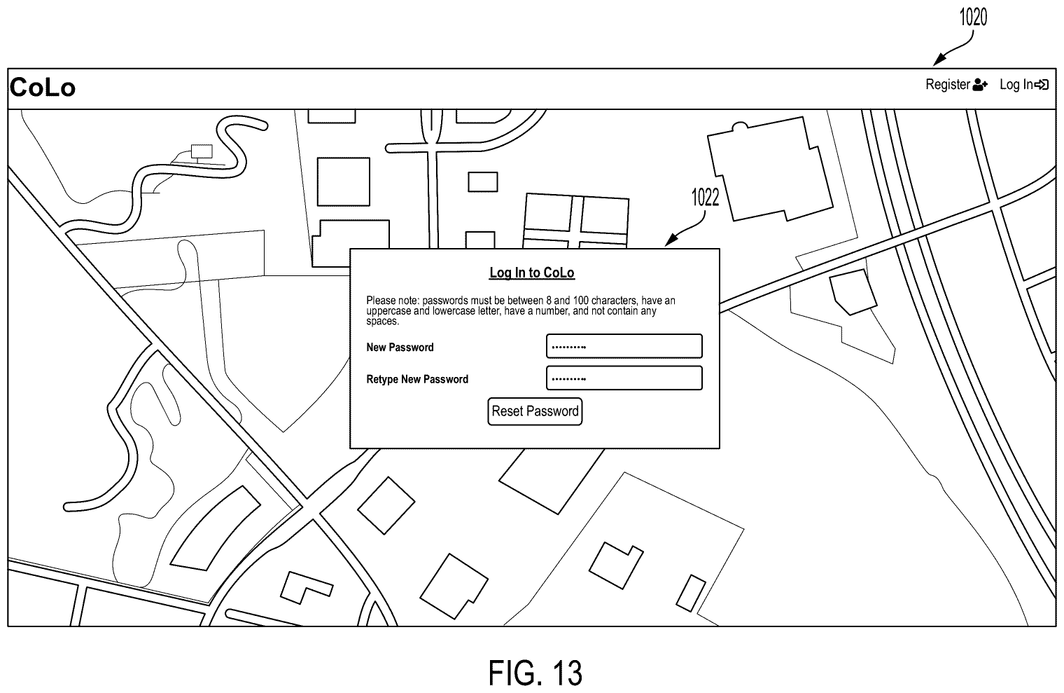

In response to submitting the information via user interface 1000, and after approval by the computer system 400, the user receives an electronic communication 1010 from the computer system 400, such as a text or email (FIG. 12), that indicates the approval of the user and that provides a link 1012 that the user can activate to access the computer system 400. In response to activation of the link 1012, a log-in user interface 1020 (FIG. 13) is displayed on the user's device and includes a log-in panel 1022 in which the user can enter a password to gain entry to the computer system 400, as would be understood by those of skill in the art of the present invention.

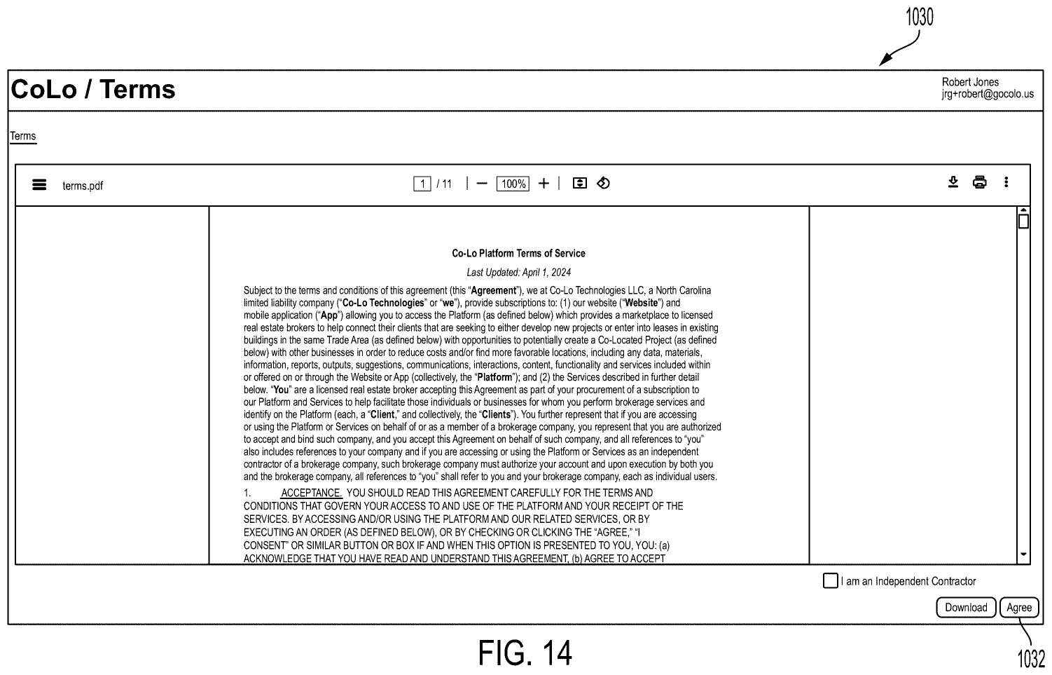

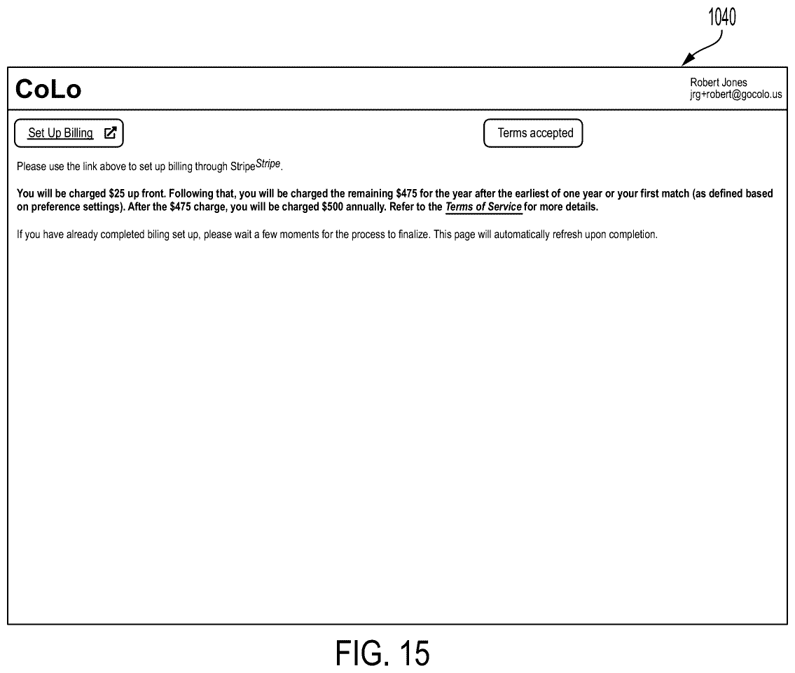

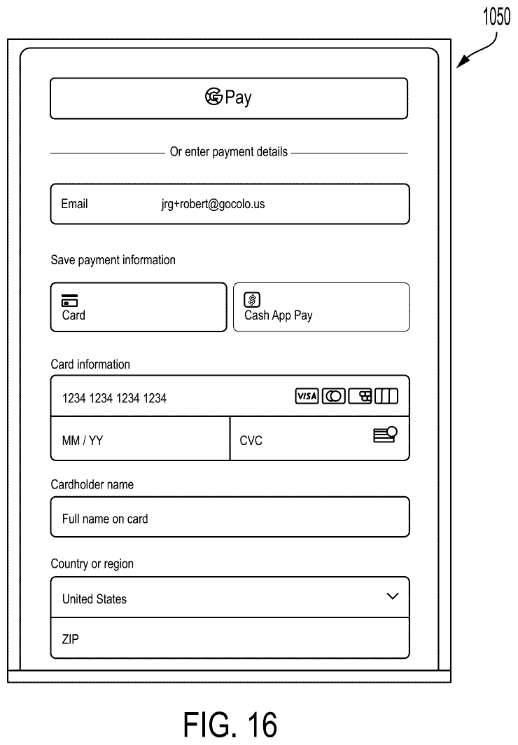

FIG. 14 illustrates a user interface 1030 that displays terms of service for access and use of the computer system 400, and to which each user must agree to via GUI control 1032. FIG. 15 illustrates a user interface 1040 for setting up billing for use of the computer system 400 and FIG. 16 illustrates an exemplary user interface 1050 for use by a user for making payment for use of the computer system 400 and the various applications and services provided thereby.

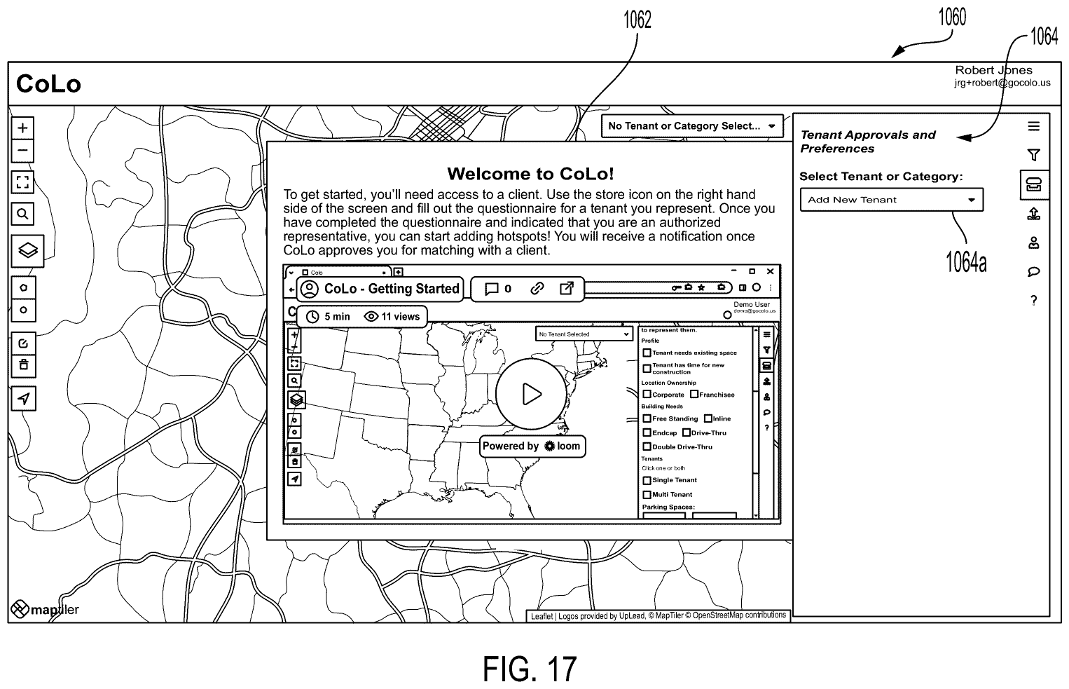

FIG. 17 illustrates a user interface 1060 that is displayed once a user is registered and has paid for access to the computer system 400 and the services provided thereby. The user interface 1060 displays a tutorial video, via window 1062, that explains how to use the computer system 400 and the various applications and services provided thereby. User interface 1060 also includes a questionnaire panel 1064, which is continued in FIGS. 18-19. The questionnaire panel 1064 includes multiple user input boxes for providing user (i.e., tenant and broker) information to the computer system 400. For example, in user input box 1064a a tenant or tenant category can be selected. In user input box 1064b, the user can indicate if he/she is a licensed real estate broker representing the tenant indicated in user input box 1064a and in the trade areas to be identified. In user input box 1064c, the user can indicate if he/she is a licensed real estate broker exclusively representing the tenant indicated in user input box 1064a and in the trade areas to be identified.

The illustrated questionnaire panel 1064 also allows the user to input tenant profile information, tenant location ownership information, tenant building needs, rent and lands costs, pre-approved co-tenants, unapproved tenant competitors, and unapproved tenant categories. For example, the user can indicate if a tenant needs existing space (i.e., does not have time or want to build new space) via input box 1064d or can indicate if a tenant has time for or wants new construction via input box 1064e. With respect to building needs, the user can indicate whether a tenant requires a free standing building via user input box 1064h, requires an inline building via user input box 1064i, requires an endcap arrangement via user input box 1064j, requires a drive-thru via user input box 1064k, or requires a double drive-thru via user input box 1064l. In addition, in the illustrated questionnaire panel 1064, the user can indicate if the tenant needs a single tenant building via user input box 1064m or if a multi-tenant building is acceptable via user input box 1064n. The illustrated questionnaire panel 1064 also allows the user to input a range of parking spaces required by the tenant via user input boxes 1064p1, 1064p2.

With respect to costs, the illustrated questionnaire panel 1064 allows the user to input a range of rent that is acceptable to the tenant via user input boxes 1064q1, 1064q2. The illustrated questionnaire panel 1064 allows the user to input a range of land costs that is acceptable to the tenant if land is to be acquired via user input boxes 1064r1, 1064r2.

The illustrated questionnaire panel 1064 allows the user to identify other co-tenants that are pre-approved (i.e., other entities that a tenant is okay with being a co-tenant with) via user input box 1064s. For example, in the illustrated embodiment, the user has identified Aldi (a grocery retailer) as the tenant in user input box 1064a (FIG. 18). Example pre-approved co-tenants that could be indicated in user input box 1064s (FIG. 19) include, but are not limited to, entities such as a coffee retailer, a pharmacy, bank, etc. The user can also indicate competitors that are not approved to be co-tenants in user input box 1064t. Unapproved competitors for Aldi could include, but are not limited to, other grocery retailers, for example. The user can also indicate categories of other tenants that are not approved to be co-tenants via user input box 1064u. For example, such categories may include, but are not limited to, specific types of retail and/or professional entities.

FIG. 20A illustrates a user interface 1070 that allows the user to draw directly on a geographical map 1072 and indicate areas that the indicated tenant in user input box 1064a would like to establish a presence. The computer system 400 allows the user to draw various shapes, such as polygons and circles, around such areas of interest. In the illustrated embodiment, the user has drawn two polygons 1074, 1076 on map 1072 indicating where the tenant, Aldi, would like to open a store. In some embodiments, information about a trade area identified by the user can be displayed to the user within or adjacent to a map showing the trade area, as illustrated in FIG. 20B. Such information may include, but is not limited to, 1) the area's infrastructure and other attributes, such as local geography, transportation infrastructure, traffic patterns, and road layout, 2) the competitive landscape, such as an area's capacity to attract customers, the competition in the area, etc., and 3) demographics and area characteristics, such as the characteristics, habits, and preferences of the local community and visitors to the area.

FIG. 20B illustrates a user interface 1070 that allows the user to draw directly on the displayed geographical map 1072 and indicate trade areas that the user would like to establish a presence in. In FIG. 20B, the user has drawn a circle 1077 around an area of the map 1072. A panel 1078 is displayed by the computer system 400 within or adjacent to the circle 1077 that provides the user with various types of information about the area within the circle 1077. In the illustrated embodiment, the panel 1078 provides the following information about the area within the circle 1077: zoning, traffic flow, transportation options, competitors to the user, median income of the population, and population density.

In some embodiments, changing the size, shape and/or configuration of an identified trade area (e.g., a polygon or circle on the map) can cause this information in panel 1078 to change. As one example, increasing and decreasing the size of a polygon or circle on a map may cause the demographics of the identified trade area to change, and this would be important information for a potential tenant to be able to see on a map. In FIG. 20B, if the user increases or decreases the size of the circle 1077, the information in the panel 1078 may change. For example, by increasing or decreasing the size of the circle 1077, information such as competitor information, zoning information, median income of the population, etc., may change within the displayed panel 1078 in real-time. Moreover, the panel 1078 may display additional types of information (or may even display fewer types of information) based on the adjusted size of the circle 1077. For example, if the size of the circle 1077 is decreased by a certain amount, there may not be any competitors of the user within the geographical area delineated by the smaller circle 1077. As a result, no competitor information would be displayed within the panel 1078. If the size of the circle 1077 is increased by a certain amount, there may be additional information, such as additional transportation options, additional zoning, etc., associated with the larger area and this additional information would be displayed within the panel 1078. This aspect of dynamic, information displayable in real-time in response to the change in size by a user of a circle or polygon within a geographical map is particularly advantageous because it allows users to make more informed decisions about geographical areas of interest.

FIG. 21 illustrates a user interface 1080 that allows files, such as .kmz, .kml, and .csv files, that indicate geographical areas of interest to the tenant to be uploaded by the computer system 400. The illustrated user interface 1080 also allows the user to indicate a radius, via user input box 1082, around a specified location on the map 1072 and in which the indicated tenant in user input box 1064a would like to establish a presence. Multiple or bulk uploads of files may be performed via user interface 1080.

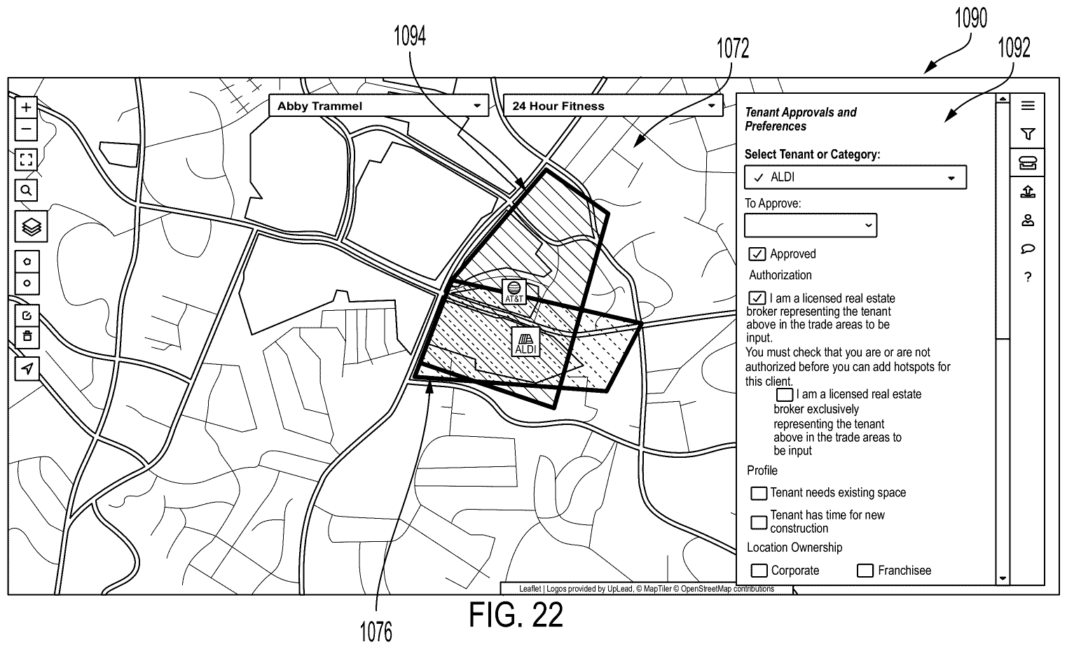

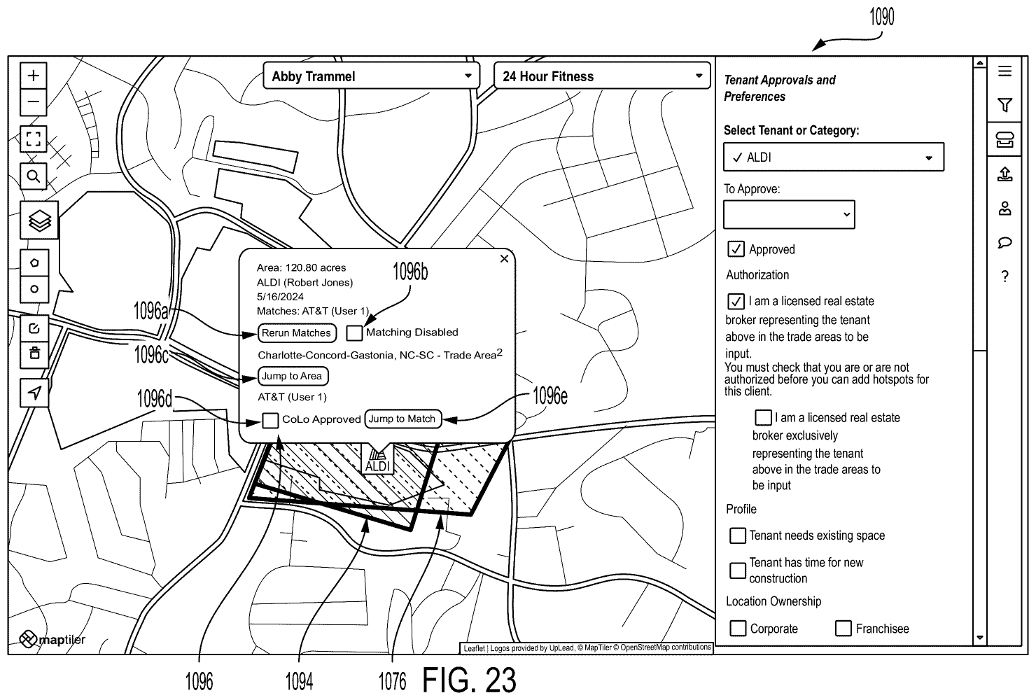

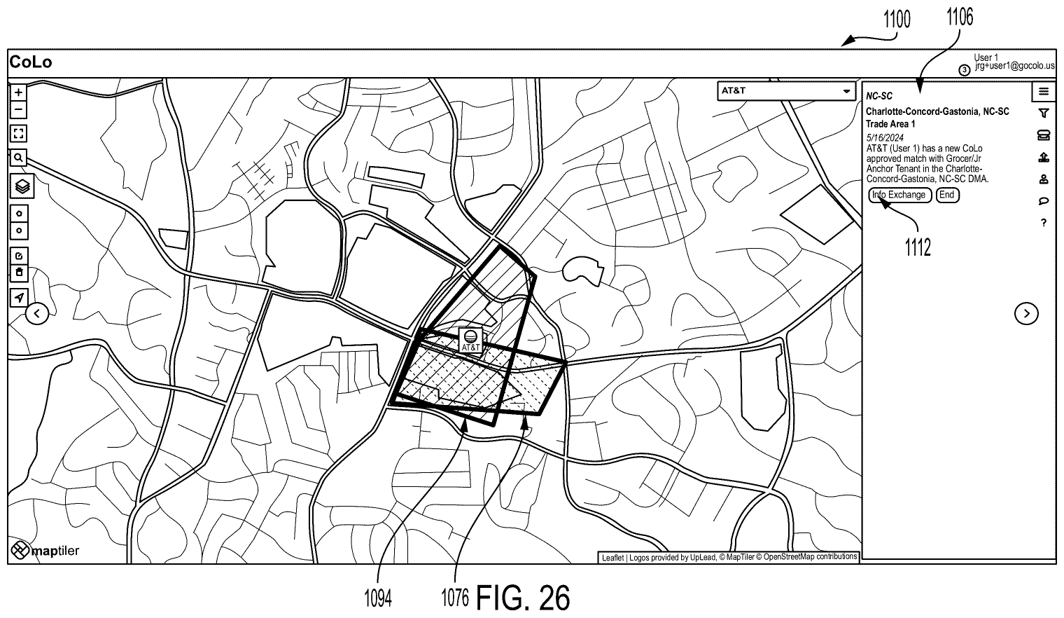

FIG. 22 illustrates a user interface 1090 that is displayed to an administrator of the computer system 400 in response to the information input via user interfaces 1060-1080. The administrator performs a background check of the tenant/broker referred to in the user interfaces 1060-1080 via the computer system 400 and, responsive to the outcome of the background check, can approve the tenant/broker via displayed panel 1092. Also illustrated in the map 1072 displayed in user interface 1090 is a polygon 1094 that indicates a geographical area of interest of an approved tenant, AT&T. The polygon 1094 overlaps the polygon 1076 of tenant Aldi, which indicates that two potential co-tenants (her Aldi and AT&T) are interested in a common trade area (i.e., the area of overlap of the two polygons 1076, 1094). The polygons 1076, 1094 may be displayed in different colors or have other identifying characteristics in some embodiments. FIG. 23 illustrates the user interface 1090 of FIG. 22 with a panel 1096 displayed therein that indicates a co-tenancy match between Aldi and AT&T and that provides additional information and includes GUI controls 1096a-1096e. For example, GUI control 1096a allows administrators of the computer system 400 to manually run matches (i.e., to utilize the computer system 400 to determine if there are any co-tenancy matches among users of the computer system 400). This is helpful particularly if user preferences have changed. GUI control 1096b allows administrators of the computer system 400 to disable matching for an area (i.e., preventing co-tenancy matches from being identified by the computer system 400). This may be automatically checked after a predetermined period (e.g., one year, etc.) of inactivity in an area, unless a user chooses to renew its use of the computer system 400, for example as a result of email (or other communication) reminders. GUI control 1096c displays area information in list view. List view displays information in a list in portion 1106 (FIG. 26) of user interface 1100, rather than on the map. GUI control 1096d marks a match as approved by the computer system 400, which then presents the match to the matched users. GUI control 1096e displays information about the match in the list view.

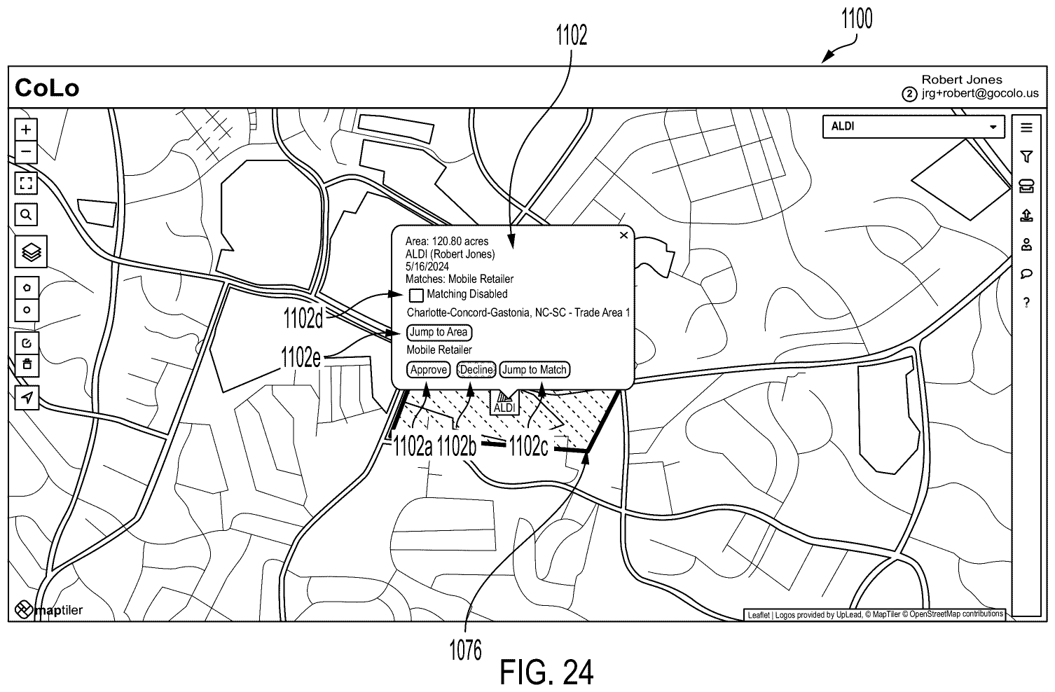

FIG. 24 illustrates a user interface 1100 that is displayed to the user that includes a panel 1102 indicating that there is a co-tenancy match between the tenant, Aldi, and another entity. The illustrated window 1102 includes GUI controls 1102a, 1102b, 1102c. GUI control 1102a allows the user (in this example, Aldi) to accept the co-tenancy match, GUI control 1102b allows the user to decline the co-tenancy match, and GUI control 1102c allows the user to jump to the co-tenancy match in the list view. The illustrated panel 1102 also includes GUI controls 1102d and 1102e. GUI control 1102d allows administrators of the computer system 400 to disable matching for an area. This is automatically checked after a predetermined time period (e.g., one year, etc.) of inactivity in an area, unless a user chooses to renew its use of the computer system, for example as a result of email (or other communication) reminders. GUI control 1102e displays area information in the list view.

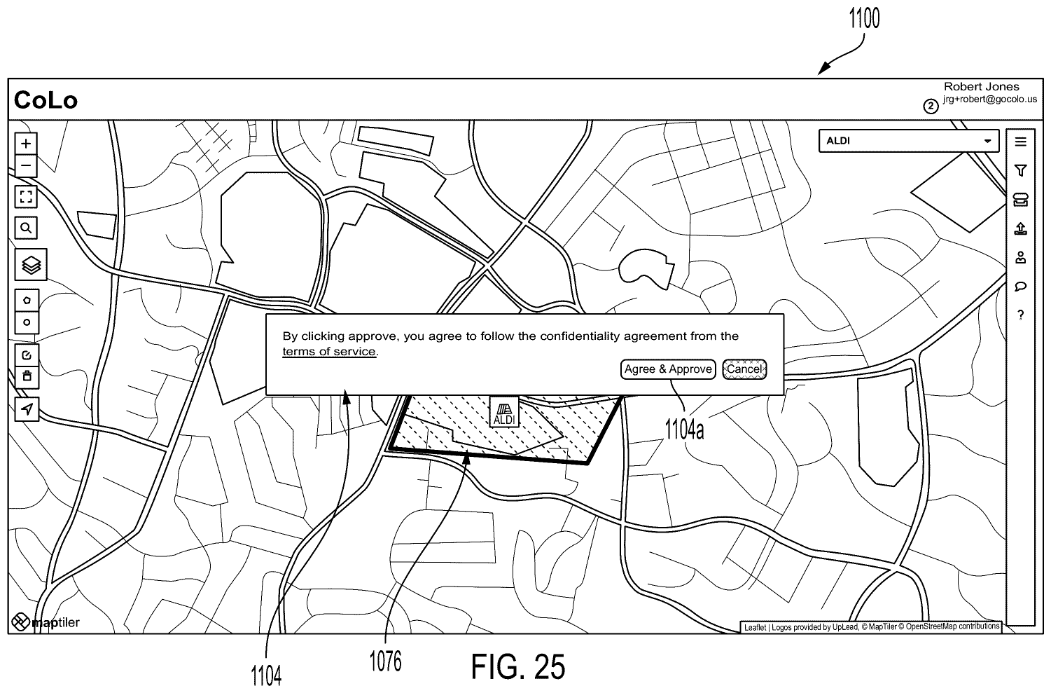

If the user (in this example, Aldi) approves the co-tenancy match via GUI control 1102a in panel 1102 of FIG. 24, another panel 1104 is then displayed to the user, as illustrated in FIG. 25. This panel 1104 requires the user to agree to adhere to the confidentiality agreement set forth in the terms of service (FIG. 14) via GUI control 1104a. The user is now waiting on the other party (in this example, AT&T) to approve the co-tenancy in a similar manner via the computer system 400.

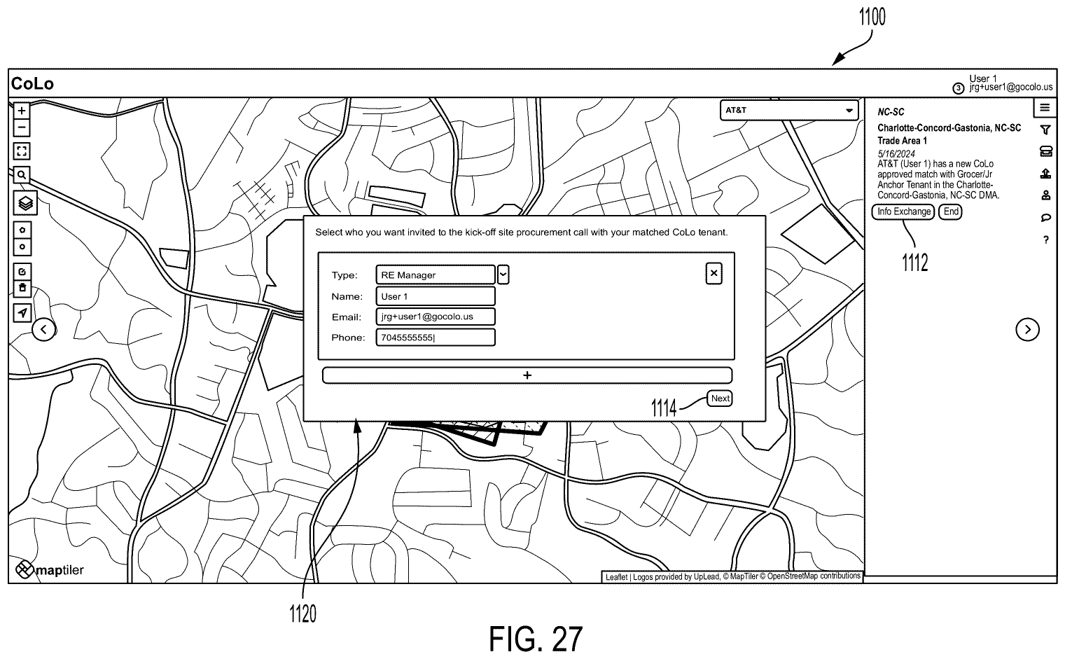

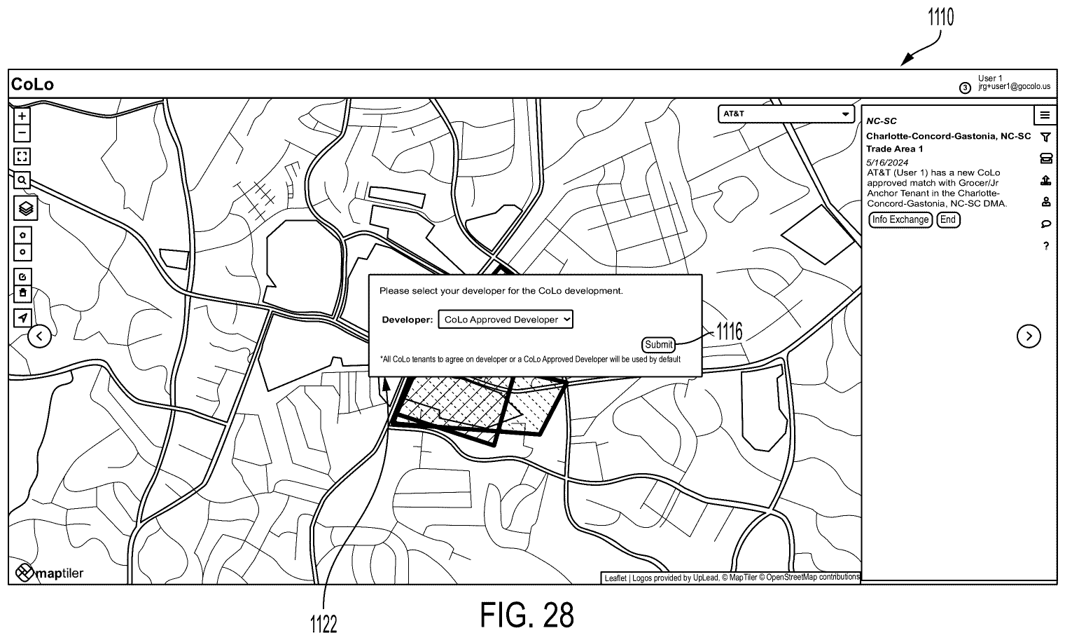

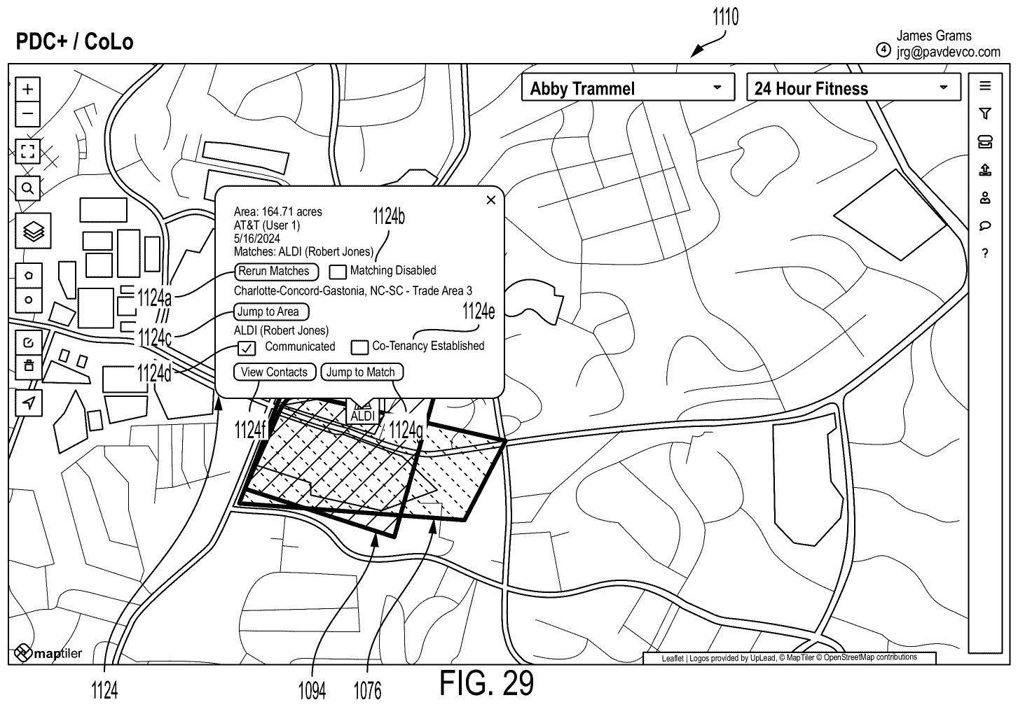

FIG. 26 illustrates a user interface 1110 that is displayed to both users (in addition to an administrator of the computer system 400) that indicates that both tenants have approved each other. Prior to the approval, each user would only be able to see the respective trade area designated by that user. Now, as illustrated in FIG. 26, each user can see the trade area information of the other user. Each tenant, or the broker for each tenant can then exchange contact information with each other via GUI control 1112. In response to clicking on GUI control 1112, a panel 1120 (FIG. 27) is presented to the user which allows the user to enter contact information for who is to participate in a kick-off telephone call or conference to discuss the co-tenancy agreement. In response to clicking on GUI control 1114, a panel 1122 (FIG. 28) is presented to the user that allows the user to select a developer for the co-tenancy agreement. A developer is someone willing to buy the land and clear it in preparation for building construction, etc. In response to clicking on GUI control 1116, both parties to the co-tenancy agreement have each other's contact information and a telephone call or on-line conference can occur to discuss the co-tenancy agreement. In some embodiments, the computer system 400 can implement the telephone call or on-line conference between the respective parties. FIG. 29 illustrates user interface 1110 that includes a panel 1124 that is displayed to a user after the telephone call or on-line conference has occurred. Both parties to the co-tenancy agreement (i.e., Aldi and AT&T in the illustrated example) are identified via panel 1124. Panel 1124 includes various GUI controls 1124a-1124g. For example, GUI control 1124a allows administrators of the computer system 400 to manually run matches (i.e., to determine if there are any co-tenancy matches among users of the computer system). This is helpful if user preferences have changed. GUI control 1124b allows administrators to disable matching for an area. This may be automatically checked after a predetermined time period (e.g., one year, etc.) of inactivity in an area, unless a user chooses to renew use of the computer system 400. GUI control 1124c displays area information in the list view. GUI control 1124d allows administrators to mark a match as communicated, meaning the match has been revealed to the matched users and they can now see who the match is by accessing the computer system via their respective user devices. GUI control 1124e allows administrators to indicate that a development has resulted from the match. GUI control 1124f allows administrators to see the contact information submitted by users for a match. GUI control 1124g shows the match information in list view.

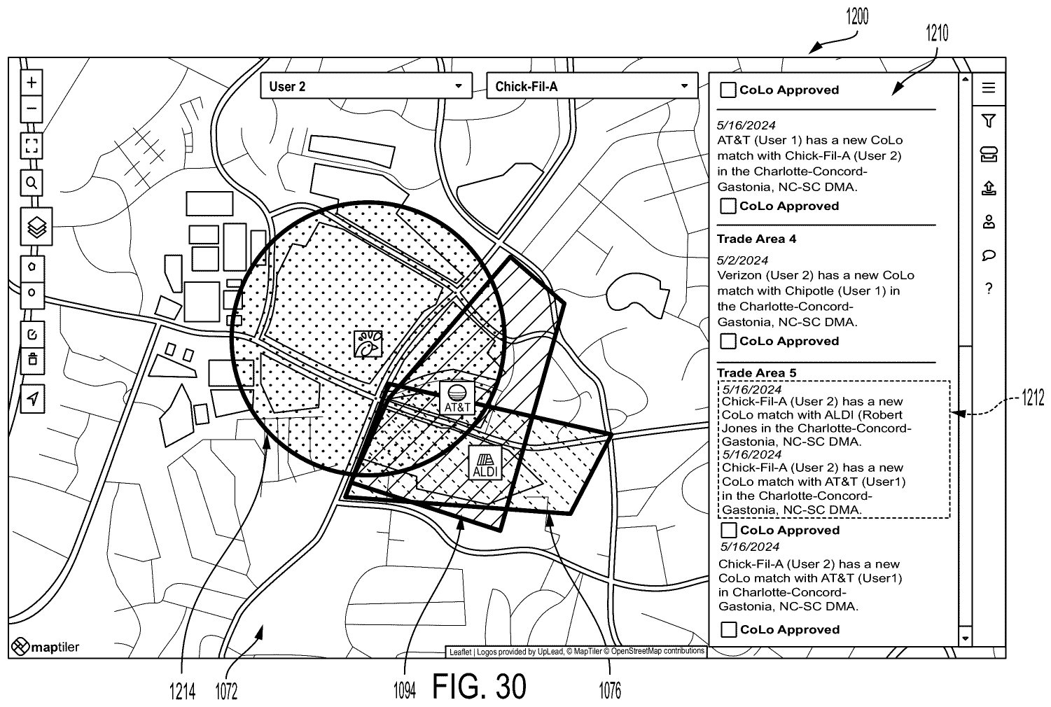

FIG. 30 illustrates a user interface 1200 that an administrator of the computer system 400 can utilize to view matches between various potential tenants. User interface 1200 includes a panel 1210 listing matches that exist between various potential tenants who have registered with the computer system 400. An administrator of the computer system 400 can scroll through the various matches in panel 1210 and view information about each one. In FIG. 30, the administrator has selected the match 1212 in panel 1210 and the matched geographical areas of each tenant are displayed in the map 1072 displayed in user interface 1200. In the selected match 1212, Chick-Fil-A has a circular geographical area of interest 1214 that overlaps with the polygon geographical areas 1076, 1094 or Aldi and AT&T, respectively. Selected match 1212 (Chick-Fil-A—Aldi) is having another match (Chick-Fil-A—AT&T) for the same area placed under it, which will create a three-way match.

FIG. 31 is a flowchart of operations for identifying co-tenant opportunities, according to some embodiments of the present invention. Initially, each prospective tenant or broker for a tenant submits a registration request to the computer system 400 (Block 2000). The user receives a temporary link in an email, text, or other electronic communication from the computer system 400 and the user logs in to the computer system 400 using the temporary link (Block 2002). If the user agrees to the terms of service of the computer system 400 and the co-tenancy identification application, referred to as “CoLo”, implemented by the computer system 400 to perform the various functions described herein, the user is then prompted to fill out a questionnaire and provide various information as described above (Block 2006). If the user rejects the terms of service, access to the user is denied (Block 2004).

Once the user has provided information via the questionnaire, a CoLo administrator is notified (Block 2008), and then the CoLo administrator can approve or reject the user (Block 2010). If the CoLo administrator approves the user, the user is allowed to receive matches for the areas they input (Block 2012). If a match between the user and other users is identified, as described above, the CoLo administrator is notified (Block 2014) and tries to find a developer for the matched users (Block 2016). In addition, the CoLo administrator, as well as each potential tenant, can reject a match between potential tenants (Block 2026). For approved matches, general information about each potential tenant and the geographical location is revealed to each potential tenant via the CoLo application (Block 2018). If each matched potential tenant accepts the match and agrees to a confidentiality agreement, as described above, the trade area of each tenant is shared with each other via the CoLo application (Block 2020). Each co-tenant then provides contact information for a telephone call or conference (Block 2022) and are informed that the CoLo application will set up the call or conference (Block 2024).

FIG. 32 illustrates a user interface 3000 that a user of the computer system 400 can utilize to identify parcels of land that the user (or a client of the user) would like to sell. In the illustrated user interface 3000, a geographic map 3002 is displayed and within which a user has drawn (or otherwise placed) a polygon 3006 around an area that the user (or a client of the user if the user is a broker) would like to sell. The computer system 400 is configured to automatically display a panel 3004 on or adjacent to the polygon 3006 that displays information about the area within the polygon. This information may change as the size or shape of the polygon 3006 is changed. In the illustrated example, the panel 3004 indicates the size of the area (e.g., in yd², etc.) within the polygon 3006, the user's identity, and the date that the polygon 3006 was drawn or placed on the map 3002. The illustrated panel 3004 also displays a size information box 3008 that contains size information (e.g., acreage information) of the area within the polygon 3006. The illustrated panel 3004 also displays a zoning information box 3010 containing information about the zoning of the area within the polygon 3006. In the illustrated example, the area within the polygon 3006 is indicated as being zoned commercial.

FIG. 33 illustrates a user interface 3020 that an administrator of the computer system 400 can utilize to view plots of land that are for sale. Plots may ultimately be visible to other users, as well. The user interface 3020 displays a geographical map 3022 and on the geographical map 3022 a “hotspot” (i.e., a desired trade area) for Aldi is indicated by the polygon 3024, and the plot 3006 for sale shown in FIG. 32 is also displayed by a dashed border. Company hotspots are indications of areas they would like to enter, while plots are specific pieces of land that are for sale. In this example, the plot 3006 drawn in FIG. 32 could be identified as a suitable plot of land for Aldi to utilize as they have shown interest in being in that area.

Example embodiments are described herein with reference to block diagrams and flow diagrams. It is understood that a block of the block diagrams and flow diagrams, and combinations of blocks in the block diagrams and flow diagrams, can be implemented by computer program instructions that are performed by one or more computer circuits, such as electrical circuits having analog and/or digital elements. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and flow diagrams, and thereby create means (functionality) and/or structure for implementing the functions/acts specified in the block diagrams and flow diagrams.

The computer program instructions described herein may be configured to transform a memory of a computer system to include one or more data structures, such as, but not limited to, arrays, extensible arrays, linked lists, binary trees, balanced trees, heaps, stacks, and/or queues. These data structures can improve the efficiency of a computer system when the computer system operates to aggregate tenant demand for real estate site locations, optimize co-tenancy opportunities, and ensure the confidentiality of tenant information.

It should also be noted that the functionality of a given block of the block diagrams and flow diagrams may be separated into multiple blocks and/or the functionality of two or more blocks of the block diagrams and flow diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Herein, a machine-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A machine-readable non-transitory storage medium may be volatile, non-volatile, or a combination of volatile and non-volatile, where appropriate.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. A computer-implemented method comprising executing, on at least one processor, the steps of:
obtaining, via respective user devices, information from each of a plurality of prospective tenants regarding one or more real estate preferences of each of the plurality of prospective tenants;
obtaining, via the respective user devices, geographic location information from each of the plurality of prospective tenants that indicates where each of the plurality of prospective tenants would like to conduct business; and
automatically identifying two or more of the plurality of prospective tenants that provided respective geographic location information that is within a predetermined distance threshold of each other.

2. The method of claim 1, further comprising automatically determining, based on previously provided information from the two or more prospective tenants, whether there are any restrictions on the two or more prospective tenants being co-tenants.

3. The method of claim 1, wherein, in response to automatically identifying the two or more of the plurality of prospective tenants that provided the respective geographic location information that is within a predetermined distance threshold of each other, the method further comprises:
automatically determining if the two or more prospective tenants have one or more similar real estate preferences; and
in response to automatically determining that the two or more prospective tenants have one or more similar real estate preferences, transmitting generic information about each of the identified two or more prospective tenants over a communications network to respective user devices of the two or more prospective tenants.

4. The method of claim 2, further comprising:
automatically determining whether it is acceptable under one or more existing agreements entered into by the two or more prospective tenants to disclose an identity of each of the two or more prospective tenants to each other; and
in response to determining that it is acceptable to disclose the identity of each of the two or more prospective tenants to each other, transmitting the identity of each of the two or more prospective tenants to each other over a communications network to the respective user devices, and displaying the geographic location information of the two or more prospective tenants via the respective user devices.

5. The method of claim 4, further comprising, in response to transmitting the identity of each of the two or more prospective tenants to the respective user devices, obtaining, via the respective user devices, an indication from each of the two or more prospective tenants if the two or more prospective tenants agree to enter into at least one of a co-tenancy development agreement, a co-tenancy leasing agreement, or a co-land use agreement with each other.

6. The method of claim 1, wherein the one or more real estate preferences is obtained from at least one user interface displayed on a display screen of each of the respective user devices.

7. The method of claim 1, wherein the one or more real estate preferences comprise one or more of the following: indoor square footage information, land parcel size information, parking space information, building type, type of drive-thru, site visibility and access information, vehicle traffic count information, household income information, rent range, land cost range, approved competitors, and unapproved competitors.

8. The method of claim 1, wherein the geographic location information is obtained from a user interactive map of a geographic region displayed on a display screen of each of the respective user devices.

9. The method of claim 8, wherein the geographic location information is obtained from the user interactive map via a location indicator positioned on the user interactive map and/or from longitude and latitude coordinates entered within a user interface associated with the user interactive map.

10. The method of claim 9, wherein the location indicator is a polygon or circle drawn on the user interactive map, and wherein information about the geographic area within the polygon or circle is displayed on or adjacent to the polygon or circle.

11. The method of claim 10, wherein the displayed information about the geographic area within the polygon or circle comprises one or more of the following types of information: zoning information, vehicle traffic information, available transportation information, user competitor information, demographic information, population density.

12. The method of claim 11, wherein the displayed information about the geographic area within the polygon or circle changes in response to a change in the size, shape, or configuration of the polygon or circle.

13. A computer-based system comprising at least one processor and a memory, the memory comprising instructions that when executed by the at least one processor cause the at least one processor to:
obtain, via respective user devices, information from each of a plurality of prospective tenants regarding one or more real estate preferences of each of the plurality of prospective tenants;
obtain, via the respective user devices, geographic location information from each of the plurality of prospective tenants that indicates where each of the plurality of prospective tenants would like to conduct business; and
automatically identify two or more of the plurality of prospective tenants that provided respective geographic location information that is within a predetermined distance threshold of each other.

14. The system of claim 13, wherein the memory further comprises instructions that when executed by the at least one processor cause the at least one processor to automatically determine, based on previously provided information from the two or more prospective tenants, whether there are any restrictions on the two or more prospective tenants being co-tenants.

15. The system of claim 13, wherein, in response to automatically identifying the two or more of the plurality of prospective tenants that provided the respective geographic location information that is within a predetermined distance threshold of each other, the memory further comprises instructions that when executed by the at least one processor cause the at least one processor to:
automatically determine if the two or more prospective tenants have one or more similar real estate preferences; and
in response to automatically determining that the two or more prospective tenants have one or more similar real estate preferences, automatically, or after review in consultation with a developer under a confidentiality agreement, transmit generic information about each of the identified two or more prospective tenants over a communications network to respective user devices of the two or more prospective tenants.

16. The system of claim 14, wherein the memory further comprises instructions that when executed by the at least one processor cause the at least one processor to:
automatically determine whether it is acceptable under one or more existing agreements entered into by the two or more prospective tenants to disclose an identity of each of the two or more prospective tenants to each other; and
in response to determining that it is acceptable to disclose the identity of each of the two or more prospective tenants to each other, transmit the identity of each of the two or more prospective tenants over the communications network to the respective user devices, and display the geographic location information of the two or more prospective tenants via the respective user devices.

17. The system of claim 16, wherein the memory further comprises instructions that when executed by the at least one processor cause the at least one processor to, in response to transmitting the identity of each of the two or more prospective tenants to the respective user devices, obtain, via the respective user devices, an indication from each of the two or more prospective tenants if the two or more prospective tenants agree to enter into at least one of a co-tenancy development agreement, a co-tenancy leasing agreement, or a co-land use agreement with each other.

18. The system of claim 13, wherein the memory further comprises instructions that when executed by the at least one processor cause the at least one processor to display at least one user interface on a display screen of each of the respective user devices, and to obtain the information regarding real estate preferences from the at least one user interface.

19. The system of claim 13, wherein the information regarding real estate location preferences comprises one or more of the following: indoor square footage information, land parcel size information, parking space information, building type, type of drive-thru, site visibility and access information, vehicle traffic count information, household income information, land cost range, rent range, approved competitors, and unapproved competitors and competitor categories.

20. The system of claim 13, wherein the memory further comprises instructions that when executed by the at least one processor cause the at least one processor to display a user interactive map of a geographic region on a display screen of each of the respective user devices, and to obtain the geographic location information from the user interactive map.

21. The system of claim 20, wherein the memory further comprises instructions that when executed by the at least one processor cause the at least one processor to obtain the geographic location information from the user interactive map via a location indicator positioned on the user interactive map and/or from longitude and latitude coordinates entered within a user interface associated with the user interactive map.

22. The system of claim 21, wherein the location indicator is a polygon or circle drawn on the user interactive map, and wherein information about the geographic area within the polygon or circle is displayed on or adjacent to the polygon or circle.

23. The system of claim 22, wherein the displayed information about the geographic area within the polygon or circle comprises one or more of the following types of information: zoning information, vehicle traffic information, available transportation information, user competitor information, demographic information, population density.

24. The system of claim 23, wherein the memory further comprises instructions that when executed by the at least one processor cause the displayed information about the geographic area within the polygon or circle to change in response to a change in the size, shape, or configuration of the polygon or circle.

25. A computer program product tangibly embodied in a non-transitory machine-readable storage medium and comprising instructions configured to cause one or more processors to perform operations comprising:
obtaining, via respective user devices, information from each of a plurality of prospective tenants regarding one or more real estate preferences of each of the plurality of prospective tenants;
obtaining, via the respective user devices, geographic location information from each of the plurality of prospective tenants that indicates where each of the plurality of prospective tenants would like to conduct business; and
automatically identifying two or more of the plurality of prospective tenants that provided respective geographic location information that is within a predetermined distance threshold of each other.

26. The computer program product of claim 25, further comprising instructions for automatically determining, based on previously provided information from the two or more prospective tenants, whether there are any restrictions on the two or more prospective tenants being co-tenants.

27. The computer program product of claim 25, wherein, in response to automatically identifying the two or more of the plurality of prospective tenants that provided the respective geographic location information that is within a predetermined distance threshold of each other, the instructions further comprise instructions for:
automatically determining if the two or more prospective tenants have one or more similar real estate preferences; and
in response to automatically determining that the two or more prospective tenants have one or more similar real estate preferences, transmitting generic information about each of the identified two or more prospective tenants over a communications network to respective user devices of the two or more prospective tenants.

28. The computer program product of claim 26, further comprising instructions for:
automatically determining whether it is acceptable under one or more existing agreements entered into by the two or more prospective tenants to disclose an identity of each of the two or more prospective tenants to each other; and
in response to determining that it is acceptable to disclose the identity of each of the two or more prospective tenants to each other, transmitting the identity of each of the two or more prospective tenants over a communications network to the respective user devices, and automatically displaying the geographic location information of the two or more prospective tenants via the respective user devices.

29. The computer program product of claim 28, further comprising instructions for, in response to transmitting the identity of each of the two or more prospective tenants to the respective user devices, obtaining, via the respective user devices, an indication from each of the two or more prospective tenants if the two or more prospective tenants agree to enter into at least one of a co-tenancy development agreement, a co-tenancy leasing agreement, or a co-land use agreement with each other.

30. The computer program product of claim 25, further comprising instructions for displaying a user interactive map of a geographic region on a display screen of each of the respective user devices, and to obtain the geographic location information from the user interactive map.

31. The computer program product of claim 30, further comprising instructions for obtaining the geographic location information from the user interactive map via a location indicator positioned on the user interactive map and/or from longitude and latitude coordinates entered within a user interface associated with the user interactive map.

32. The computer program product of claim 31, wherein the location indicator is a polygon or circle drawn on the user interactive map, and further comprising instructions for displaying information about the geographic area within the polygon or circle or adjacent to the polygon or circle.

33. The computer program product of claim 32, wherein the displayed information about the geographic area within the polygon or circle comprises one or more of the following types of information: zoning information, vehicle traffic information, available transportation information, user competitor information, demographic information, population density.

34. The computer program product of claim 33, further comprising instructions for changing the displayed information about the geographic area within the polygon or circle in response to a change in the size, shape, or configuration of the polygon or circle.
